(19) United States
(12) Patent Application Publication
(10) Pub. No.: US 2025/0318524 A1
(43) Pub. Date: Oct. 16, 2025

(54) ANTIMICROBIAL COATING COMPOSITION AND METHOD OF USE THEREOF

(71) Applicant: Nano and Advanced Materials Institute Limited, Hong Kong (CN)

(72) Inventors: Cheuk Ka POON, Hong Kong (CN); Chun Hay KO, Hong Kong (CN); Wing Man CHAN, Hong Kong (CN)

(21) Appl. No.: 18/635,176

(22) Filed: Apr. 15, 2024

(51) Int. Cl. A01N 33/04; A01N 25/22; A01N 25/26; C08L 5/08; D06M 16/00

(52) U.S. Cl. CPC A01N 33/04; A01N 25/22; A01N 25/26; C08L 5/08; D06M 16/00

(57) ABSTRACT

A coating composition precursor comprising an antimicrobial agent, an esterification catalyst, and a chitosan conjugate, wherein the chitosan conjugate comprises a repeating unit of Formula I:

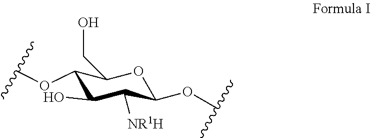

or a conjugate salt thereof, wherein R¹ is —(C═O)(CH₂)mCO₂H, and m is a whole number selected from 1-12; a coating composition comprising the coating composition precursor, methods of use and products thereof.

### TECHNICAL FIELD

The present disclosure generally relates to the area of coatings. More particularly, the present disclosure relates to a coating composition precursor useful for imparting antimicrobial properties to textiles, a coating composition thereof and methods of using the coating composition.

### BACKGROUND

Textiles are being used in different applications in our daily lives, ranging from personal care, clothing, bedding, furnishing, etc. in household, commercial and public premises. Textiles, especially wearable textiles can mediate transmission of bacteria and viruses, which can result in spreading of infectious diseases from individuals to another. With the increasing awareness of health and hygiene, the global demand for antimicrobial textiles has been growing rapidly in recent years. Antimicrobial treatment can eliminate or suppress the growth of microorganisms on textiles, hence reducing the spread of pathogenic infections through direct or indirect contact. While textiles made of natural fibers (e.g. cotton, viscose, linen) are also susceptible to microbial decomposition, antimicrobial treatment can prolong the shelf life of textiles and protect the users from microbial contamination. There are two common approaches for conferring antimicrobial property on textiles—(1) antimicrobial treatment on fibers/yarns before they are weaved into textiles and (2) antimicrobial treatment on textiles during manufacturing process.

Antimicrobial treatment on fiber/yarn provides a relatively long-lasting antimicrobial effect on textiles. US20130183495A1 discloses an antimicrobial fabric made of polymer fibers comprising polyhexamethylene biguanide (PHMB). Antimicrobial performance of the fabrics is maintained after at least 200 laundering cycles. Nevertheless, fiber/yarn treatment is applicable to synthetic fibers/yarns while fabrics made of all natural fibers, such as cotton cannot be adopted.

Biguanides in the form of chlorhexidine and polyhexamethylene biguanide (PHMB), are effective in inhibiting bacteria and viruses by disrupting the cellular membrane of the microorganisms. When applied on substrates with negatively charged functional groups, the cationic charged biguanides bind to the substrate surface via electrostatic interaction. These features make biguanides good candidates in functionalizing cotton-based fabrics, which contain negatively charged hydroxyl groups for electrostatic binding. Laundry activities, however, can decrease the antimicrobial protection on the fabrics due to complexation of biguanides with anionic surfactants, which are common ingredients present in laundry detergents, as well as detachment of biguanide agents from mechanical actions in laundry process.

Antimicrobial treatment on fabrics generally involves coating the fabrics with an antimicrobial finish. The fabric is first passed through a bath filled with antimicrobial finish. The impregnated fabric is padded and heated to fix the antimicrobial agent on the fibers. Durability of antimicrobial performance on fabrics relies heavily on binding of antimicrobial agent. Yet, a significant reduction of antimicrobial performance of treated fabric after laundry has been reported in some commercial finish products. Some commercial antimicrobial finishes and fabric products are even advised not to be laundered and exposed to anionic laundry detergents, which are common ingredients present in laundry products.

Chitosan is a linear polysaccharide composed of β-(1-4)-linked D-glucosamine units (deacetylated) and N-acetyl-D-glucosamine units (acetylated). Most commercially available chitosan is produced from deacetylation of chitin, a process which reveals primary amino groups on the glucosamine backbone. Native chitosan is insoluble in pure water and organic solvent, but soluble in water in the presence of organic acid, such as acetic acid. It can be chemically functionalized to become water-soluble and bear antibacterial features. Chitosan and its derivatives adopted as antibacterial agent and form antimicrobial coating with biguanides on textiles are disclosed in prior arts:

US20210222357A1 discloses the making of antimicrobial textile material by treating the substrates with solution containing chitosan, polyhexamethylene biguanide (PHMB), quaternary ammonium organosilane compound and propiconazole. The solution can be applied with at least one functional agent, including softener and antistatic agent, by pad-dry-cure on textiles composed of cotton, polyester and spandex, and combinations thereof. The treated fabrics exhibited antibacterial activity after 25 laundry cycles.

U.S. Pat. No. 9,487,912B2 discloses the coating of fabrics and textiles with antimicrobial solution composing chitosan, polyhexamethylene biguanide (PHMB) as antiviral agents. The components can be delivered in the form of textile treating agents, including softeners, on cotton, acrylic polyester and spandex fabrics, or combinations thereof, by pad-dry-cure coating.

Cheng et al., reported the modification of chitosan with N-halamine. The antibacterial N-halamine functionalized chitosan formed coating on cotton fabrics with crosslinking agent 1,2,3,4-butanetetracarboxylic acid. Antibacterial performance of the fabrics could be recharged by chlorination of the coated fabrics (Cheng, X.; Ma, K.; Li, R.; Ren, X.; Huang, T. S., Antimicrobial coating of modified chitosan onto cotton fabrics. Applied Surface Science 2014, 309, 138-143.).

Yang et al., reported the preparation of antibacterial cotton gauze dressing by grafting polyhexamethylene guanidine onto cotton gauze surface, followed by adsorption of chitosan onto the modified surface. (Yang, C.; Liu, G.; Chen, J.; Zeng, B.; Shen, T.; Qiu, D.; Huang, C.; Li, L.; Chen, D.; Chen, J.; Mu, Z.; Deng, H.; Cai, X., Chitosan and polyhexamethylene guanidine dual-functionalized cotton gauze as a versatile bandage for the management of chronic wounds. Carbohydrate Polymers 2022, 282, 119130.)

Amine-carboxylic acid coupling and esterification reactions are common methods to introduce antibacterial functionalities to chitosan and enhance solubility of chitosan in water. Water-soluble chitosan derivatives form aqueous based solution with antimicrobial agents or finishing agents for coating on textiles are disclosed in prior arts:

US2020299417A1 discloses the method of making water-soluble chitosan-derivative compounds, including chitosan-arginine, chitosan-amino acid compounds, chitosan-acid amine compounds and chitosan-guanidine compounds. EDC/(sulfo-) NHS coupling is one of the disclosed methods to conjugate carboxyl group of arginine to amino groups on chitosan. The disclosed chitosan derivatives are inherently antibacterial.

US2021025110A1 discloses the making of water-soluble chitosan derivatives by esterification, which involves reaction between carboxyl groups of amino acids and hydroxyl groups on chitosan. The amino acid-functionalized chitosan is inherently antibacterial and forms an aqueous solution with one to four antibacterial agents, including azole compounds, silver ions, polyhexamethylene biguanide (PHMB), and quaternary ammonium organosilane. The formulations are applied to 100% cotton, 100% viscose and polyester/cotton blend textiles by exhaustion. Laundry of textiles coated with the disclosed formulations is only compatible with non-ionic laundry detergent. Rinsing of the washed textiles with citric acid is also required at the end of each laundry cycle. The substrates exhibit antibacterial activities after 5, 10 and 30 laundry cycles.

Modification of chitosan with different dicarboxylic acids has been reported. The dicarboxylic acids serve as crosslinkers, which enable chitosan to transform into membranes and hydrogels:

Cai et al., reported the formation of chitosan membranes with adipic acid, which formed amide crosslinks with chitosan by vacuum heating at 80, 90 and 100° C. without coupling agent (Cai, M.; Gong, J.; Cao, J.; Chen, Y.; Luo, X., In situ chemically crosslinked chitosan membrane by adipic acid. Journal of Applied Polymer Science 2013, 128 (5), 3308-3314.).

Ghosh et al., reported the formation of chitosan membranes with adipic acid, which formed amide crosslinks with chitosan when drying from solution forms without coupling agents (Ghosh, A.; Ali, M. A., Studies on physicochemical characteristics of chitosan derivatives with dicarboxylic acids. Journal of Materials Science 2012, 47 (3), 1196-1204.).

Chen et al. employed dicarboxylic acids to form ionic crosslinking with chitosan to make porous membrane (Chen, P.-H.; Kuo, T.-Y.; Liu, F.-H.; Hwang, Y.-H.; Ho, M.-H.; Wang, D.-M.; Lai, J.-Y.; Hsieh, H.-J., Use of Dicarboxylic Acids to Improve and Diversify the Material Properties of Porous Chitosan Membranes. Journal of Agricultural and Food Chemistry 2008, 56 (19), 9015-9021.).

Sole et al., reported the use of adipic acid as a crosslinker for making chitosan films with improved physical-mechanical properties for packaging application. The crosslinking reaction was mediated by DMTMM, resulting in conjugating both carboxyl ends of adipic acid to amino groups on chitosan (Sole, R.; Buranello, C.; Di Michele, A.; Beghetto, V., Boosting physical-mechanical properties of adipic acid/chitosan films by DMTMM cross-linking. International Journal of Biological Macromolecules 2022, 209, 2009-2019.)

Suwattanachai et al., prepared chitosan hydrogel by reacting chitosan in succinic acid solution via EDC/NHS coupling. The succinic acid was used as crosslinking agent (Suwattanachai, P.; Pimkhaokham, A.; Chirachanchai, S., Multi-functional carboxylic acids for chitosan scaffold. International Journal of Biological Macromolecules 2019, 134, 156-164.).

Valderruten et al., prepared chitosan hydrogel by reacting chitosan in solutions of succinic acid, glutaric acid and adipic acid via EDC/NHS coupling. The dicarboxylic acids were used as crosslinking agents (Valderruten, N. E.; Valverde, J. D.; Zuluaga, F.; Ruiz-Durántez, E., Synthesis and characterization of chitosan hydrogels cross-linked with dicarboxylic acids. Reactive and Functional Polymers 2014, 84, 21-28).

Preparation of pH-responsive hydrogels from modified chitosan has also been reported: Da Silva et al., reported the addition of carboxylate groups to chitosan by oxidation to make soluble chitosan derivative. When dissolved in diluted hydrochloric acid, the chitosan derivative was crosslinked and formed pH-responsive hydrogel (Botelho da Silva, S.; Krolicka, M.; van den Broek, L. A. M.; Frissen, A. E.; Boeriu, C. G., Water-soluble chitosan derivatives and pH-responsive hydrogels by selective C-6 oxidation mediated by TEMPO-laccase redox system. Carbohydrate Polymers 2018, 186, 299-309).

Although chitosan can be chemically functionalized to become water-soluble and is widely adopted as antibacterial agent for antimicrobial coating on textiles, as well as being scaffolds for making membrane and hydrogels by crosslinking with dicarboxylic acid, the use of chitosan to prepare a film-forming agent for protecting antibacterial ingredients on textiles coating from laundry is still an urgent need.

### SUMMARY

In a first aspect, provided herein is a coating composition precursor comprising:
an antimicrobial agent;
an esterification catalyst; and
a chitosan conjugate, wherein the chitosan conjugate comprises a repeating unit of Formula I,

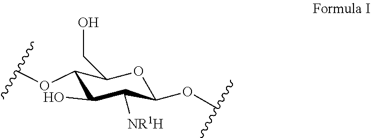

or a conjugate salt thereof, wherein
R¹ is —(C═O)(CH₂)ₘCO₂H; and
m is a whole number selected from 1-12.

In certain embodiments, the antimicrobial agent is selected from the group consisting of biguanides comprising chlorhexidine salts, polyhexamethylene biguanide (PHMB), polyaminopropyl biguanide (PAPB), and a combination thereof.

In certain embodiments, the esterification catalyst is selected from the group consisting of sodium bisulfate, potassium bisulfate, sodium hypophosphite, potassium hypophosphite, and a combination thereof.

In certain embodiments, m is a whole number selected from 2-12.

In certain embodiments, the antimicrobial agent is selected from the group consisting of biguanides comprising chlorhexidine salts, polyhexamethylene biguanide (PHMB), polyaminopropyl biguanide (PAPB), and a combination thereof; the esterification catalyst is selected from the group consisting of sodium bisulfate, potassium bisulfate, sodium hypophosphite, potassium hypophosphite, and a combination thereof; and m is a whole number selected from 2-12.

In certain embodiments, the antimicrobial agent comprises chlorhexidine acetate or polyhexamethylene biguanide (PHMB); the esterification catalyst comprises sodium hypophosphite; and m is 4.

In certain embodiments, the chitosan conjugate further comprises a repeating unit of Formula II and optionally a repeating unit of Formula III,

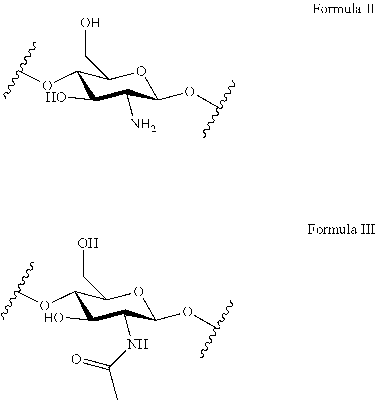

wherein the repeating unit of Formula I accounts for 6.67%-31.25% based on a total number of the repeating units of Formula I, repeating units of Formula II, and optionally the repeating units of Formula III in the chitosan conjugate.

In a second aspect, provided herein is a coating composition comprising the coating composition precursor described herein and at least one solvent.

In certain embodiments, the at least one solvent comprises water.

In certain embodiments, the coating composition further comprises an additive, wherein the additive comprises a softener or cetyltrimethylammonium bromide.

In certain embodiments, the softener comprises a hydrophilic silicone softener.

In certain embodiments, the coating composition comprises about 0.01-0.2% by weight of the chitosan conjugate, about 0.1-5% of the antimicrobial agent by weight, about 1-10% of the softener by weight, about 0.01-0.1% of the cetyltrimethylammonium bromide by weight, about 0.01-0.1% of the esterification catalyst by weight, and about 84.6-98.7% of the at least one solvent by weight.

In certain embodiments, the coating composition comprises about 0.1% of the chitosan conjugate by weight, about 1% of the antimicrobial agent, by weight about 10% of the softener by weight, about 0.1% of the cetyltrimethylammonium bromide, and about 0.1% of the esterification catalyst by weight. and about 88.7% of the at least one solvent by weight, wherein the antimicrobial agent comprises a chlorhexidine acetate.

In certain embodiments, the coating composition comprises about 0.1% of the chitosan conjugate by weight, about 5% of the antimicrobial agent by weight, about 10% of the softener by weight, 0.1% of the cetyltrimethylammonium bromide by weight, and about 0.1% of the esterification catalyst by weight and about 84.7% of the at least one solvent by weight, wherein the antimicrobial agent comprises a polyhexamethylene biguanide.

In a third aspect, provided herein is a coated textile comprising a textile and the coating composition precursor described herein disposed on a surface of the textile.

In certain embodiments, at least a portion of the chitosan conjugate forms a covalent bond with the surface of the textile.

In certain embodiments, the coated textile exhibits at least 90% antimicrobial effect against one or more microbes selected from the group consisting of a bacteria, a virus, a combination thereof after 10 laundry cycles conducted in accordance with AATCC 61-2A or 50 home laundry cycles.

In a fourth aspect, provided herein is a method of preparing a coated textile, the method comprising: contacting a textile with the coating composition described herein thereby forming an uncured coated textile and curing the uncured coated textile thereby forming the coated textile.

In certain embodiments, the curing step is conducted under conditions in which at least a portion of the chitosan conjugate forms a covalent bond with a surface of the textile.

In certain embodiments, the textile comprises a cellulosic fiber.

In certain embodiments, the curing comprises heating the uncured coated textile at 120° C. to 160° C.

In certain embodiments, the method further comprises a pre-treatment step prior to the step of contacting the textile with the coating composition, wherein the pre-treatment step comprises: contacting the textile with sugar acid and sodium hypophosphite thereby forming an uncured pretreated textile, and curing the uncured pretreated textile under conditions in which at least a portion of the sugar acid forms a covalent bond with a surface of the textile.

In certain embodiments, the textile comprises cotton and one or more of polyethylene terephthalate and spandex.

### BRIEF DESCRIPTION OF DRAWINGS

The appended drawings, where like reference numerals refer to identical or functionally similar elements, contain figures of certain embodiments to further illustrate and clarify the above and other aspects, advantages, and features of the present disclosure. It will be appreciated that these drawings depict exemplary embodiments and as such are not intended to limit the scope of this disclosure. The methods described herein will be described and explained with additional specificity and detail through the use of the accompanying drawings.

FIG. 1 depicts a chemical structure of chitosan conjugate.

FIG. 2 depicts a schematic illustration depicting chitosan-acid conjugate formed by chitosan and dicarboxylic acid (e.g. adipic acid).

FIG. 3 depicts a synthetic route for preparing chitosan-adipic acid conjugate by EDC-NHS carbodiimide coupling reaction according to certain embodiments described herein.

FIG. 4 shows schematic images and an exemplary process of the reaction and purification of chitosan-adipic acid conjugate synthesized from EDC-NHS carbodiimide or DMTMM coupling reaction.

FIG. 5 depicts FTIR spectra of adipic acid, chitosan and chitosan-adipic acid conjugate prepared by EDC-NHS carbodiimide coupling reaction.

FIG. 6 depicts SEC (0.5 M acetic acid, 30° C.) traces for chitosan and chitosan-adipic acid conjugate prepared by EDC-NHS carbodiimide coupling reaction.

FIG. 7A shows an image of solubility test of chitosan in water.

FIG. 7B shows an image of solubility test of chitosan-adipic acid conjugate prepared by EDC-NHS carbodiimide coupling reaction in water.

FIG. 8A shows an image of chitosan-adipic acid conjugate prepared by EDC-NHS carbodiimide coupling reaction dispersed in water.

FIG. 8B shows an image of chitosan-adipic acid conjugate prepared by EDC-NHS carbodiimide coupling reaction precipitated in laundry detergent (standard reference detergent AATCC 1993) solution.

FIG. 9 depicts a synthetic route for preparing chitosan-adipic acid conjugate by DMTMM coupling reaction according to certain embodiments described herein.

FIG. 10 shows a 1H-NMR spectrum (500 MHZ) of chitosan-adipic acid conjugate synthesized by DMTMM coupling (The acetylated-glucosamine unit on chitosan conjugate is not presented).

FIG. 11 depicts FTIR spectra of adipic acid, chitosan and chitosan-adipic acid conjugate prepared by DMTMM coupling reaction.

FIG. 12 depicts SEC (0.5 M acetic acid, 30° C.) traces for chitosan and chitosan-adipic acid conjugate prepared by DMTMM coupling reaction.

FIG. 13 shows comparative 1H-NMR spectra (500 MHZ) of unreacted chitosan, unreacted adipic acid and chitosan-adipic acid conjugate synthesized by DMTMM coupling (The acetylated-glucosamine unit on chitosan and chitosan-adipic acid conjugate are not presented).

FIG. 14 shows comparative images of solubility test of chitosan-adipic acid conjugate prepared by DMTMM coupling reaction in acidic aqueous (pH=2), water (pH=7), alkaline aqueous (pH=9 and 12).

FIG. 15A depicts the chemical structure of chlorhexidine.

FIG. 15B depicts the chemical structure of chlorhexidine gluconate.

FIG. 15C depicts the chemical structure of chlorhexidine acetate.

FIG. 15D depicts the chemical structure of polyhexamethylene biguanide (PHMB).

FIG. 16 shows images of the color of chlorhexidine gluconate solution (20 wt. %) obtained during storage.

FIG. 17A shows an image of an aqueous solution containing chitosan-adipic acid conjugate after adding CTAB and chlorhexidine acetate or polyhexamethylene biguanide (PHMB).

FIG. 17B shows a comparative image of the aqueous solution of FIG. 17A after adding a softener JX-090 and sodium hypophosphite.

FIG. 18 shows comparative images of the appearance of formulations ABV-S29 and ABV-S34 during three-month storage under accelerated condition, at month 0, 1, and 3.

FIG. 19 depicts a schematic illustration depicting the coating of the coating composition on the textile by pad-dry-cure coating according to certain embodiments described herein.

FIG. 20 depicts a schematic illustration depicting the chitosan-adipic acid conjugate.

FIG. 21 depicts a modification with sugar acid of textiles with a cotton content less than 50% for efficient binding with pH-responsive chitosan-adipic acid conjugate according to certain embodiments described herein (note: NH3⁺ moieties on the chitosan polymer have been removed for clarity).

FIG. 22 depicts a schematic process of pad-dry-cure coating of ABV-S29 (steps 4-6) and ABV-S34 (steps 1-6) formulations.

FIG. 23 depicts a table for comparing different fabrics of coral colors coated by 10% softener only and ABV-S29 and ABV-S34.

FIG. 24 depicts a table for comparing different fabrics of blue colors coated by 10% softener only and ABV-S29 and ABV-S34.

FIG. 25 depicts L-shaped textiles specimens (A: face side; B: back side) for texture analysis of textiles measured by Textiles Touch Tester (FTT).

FIG. 26 depicts a schematic illustration depicting the coated textiles in use (A) and the function of the coating composition during laundry (B).

FIG. 27A depicts the antibacterial performance of ABV-S32-coated polyester/cotton/spandex (62/33/5) against S. aureus after 0 and 5 home laundry cycles.

FIG. 27B depicts the antibacterial performance of ABV-S32-coated polyester/cotton/spandex (62/33/5) against E. coli after 0 and 5 home laundry cycles.

FIG. 28A depicts the antimicrobial performance of ABV-S32-coated polyester/cotton/spandex (62/33/5) after a pre-treatment against S. aureus after 0 and 5 home laundry cycles.

FIG. 28B depicts the antimicrobial performance of ABV-S32-coated polyester/cotton/spandex (62/33/5) after a pre-treatment against E. coli after 0 and 5 home laundry cycles.

FIG. 29 depicts the SEM images at 100×, 950× and 5000× of 100% cotton without any coating.

FIG. 30 depicts the SEM images at 100×, 950× and 4000× of 100% cotton coated by ABV-S29.

FIG. 31 depicts the SEM images at 950× and 5000× of 100% cotton coated by ABV-S29 after 10, 30, and 50 home laundry cycles.

FIG. 32 depicts the SEM images at 100×, 950× and 5000× of polyester/cotton/spandex (62/33/5) without any coating.

FIG. 33 depicts the SEM images at 100×, 950× and 5000× of polyester/cotton/spandex (62/33/5) pretreated by GA and coated by ABV-S34.

FIG. 34 depicts the SEM images at 950× and 5000× of polyester/cotton/spandex (62/33/5) pretreated by GA and coated by ABV-S34 after 10, 30, and 50 home laundry cycles.

### DETAILED DESCRIPTION

Provided herein is a coating composition precursor comprising an antimicrobial agent, an esterification catalyst; and a chitosan conjugate as described herein. The chitosan conjugate is insoluble in alkaline aqueous solution and forms aqueous-based antimicrobial coating with antimicrobial agent on textiles. The coating composition precursor and the coating composition described herein can advantageously demonstrates persistent antibacterial effect against gram-positive and gram-negative bacteria; and antiviral effect against human coronavirus after 50 laundry cycles.

### Definitions

The definitions of terms used herein are meant to incorporate the present state-of-the-art definitions recognized for each term in the field of biotechnology. Where appropriate, exemplification is provided. The definitions apply to the terms as they are used throughout this specification, unless otherwise limited in specific instances, either individually or as part of a larger group.

When trade names are used herein, applicants intend to independently include the trade name product formulation, the generic drug, and the active pharmaceutical ingredient(s) of the trade name product.

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. patent law; e.g., they can mean “includes”, “included”, “including”, and the like; and that terms such as “consisting essentially of” and “consists essentially of” have the meaning ascribed to them in U.S. patent law, e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10%, ±7%, ±5%, ±3%, ±1%, or ±0% variation from the nominal value unless otherwise indicated or inferred.

Provided herein is a coating composition precursor comprising: an antimicrobial agent; an esterification catalyst; and a chitosan conjugate, wherein the chitosan conjugate comprises a repeating unit of Formula I,

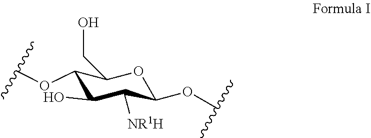

or a conjugate salt thereof, wherein R¹ is —(C═O)(CH₂)ₘCO₂H; and m is a whole number selected from 1-12.

In certain embodiments, the chitosan conjugate can further comprise D-glucosamine repeating units (Formula II) and optionally acetyl-D-glucosamine repeating units (Formula III):

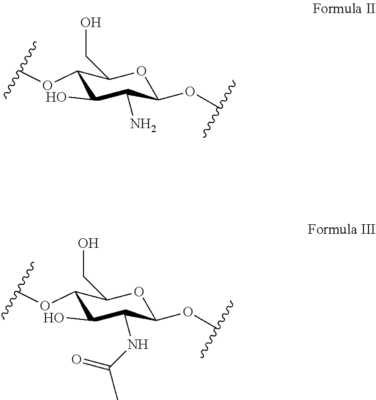

The repeating unit of Formula I can account for between 0.5-50%, 1-50%, 5-50%, 5-45%, 1-45%, 1-40%, 5-35%, 6-35%, 6-34%, 7-34%, 7-30%, 7-25%, 7-20%, 7-15%, 7-10%, 7-9%, 10-35%, 15-35%, 20-35%, 25-35%, 26-35%, 27-35%, 28-35%, or 28-34% of the repeating units in the chitosan conjugate (based on the total number of repeating units of Formula I, repeating units of Formula II, and repeating units of Formula III). In certain embodiments, the repeating unit of Formula I accounts for about 7-8.3% of the repeating units in the chitosan conjugate. In certain embodiments, the repeating unit of Formula I accounts for about 28-34% of the repeating units in the chitosan conjugate.

The chitosan conjugate can comprise between 30-99.4%, 35-99%, 40-99%, 45-99%, 45-95%, 45-90%, 45-85%, 45-80%, 45-75%, 45-74%, 45-73%, 45-72%, 46-72%, 50-99%, 55-99%, 60-99%, 65-99%, 70-99%, 70-95%, 70-94%, 70-93%, or 71-93% of repeating unit of Formula II (based on the total number of repeating units of Formula I, repeating units of Formula II, and repeating units of Formula III). In certain embodiments, the repeating unit of Formula II accounts for about 73.2% to about 88.2% of the repeating units in the chitosan conjugate.

The chitosan conjugate can comprise between 0.01-20%, 0.5-20%, 1-20%, 5-20%, 10-20%, 15-20%, 1-15%, 1-10%, 5-15%, or 5-10% of repeating unit of Formula III (based on the total number of repeating units of Formula I, repeating units of Formula II, and repeating units of Formula III). In certain embodiments, the repeating unit of Formula III accounts for about 5% to about 20% of the repeating units in the chitosan conjugate.

In certain embodiments, the repeating unit of Formula I, repeating unit of Formula II, and repeating unit of Formula III accounts for 6.67-31.25%, 54.05-88.44%, and 4.76-20% of the repeating units of in the chitosan conjugate (based on the total number of repeating units of Formula I, repeating units of Formula II, and repeating units of Formula III), respectively.

In certain embodiments, m is a whole number selected from the group consisting of 2-12, 2-11, 2-10, 2-9, 2-8, 2-7, 2-6, 2-5, 2-4, 2-3, 3-12, 4-12, 5-12, 6-12, 7-12, 8-12, 9-12, 10-12, 11-12, 2-6, and 3-5. In certain embodiment, m is 4.

In certain embodiments, the antimicrobial agent comprises a biguanide, such as chlorhexidine salts, polyhexamethylene biguanide (PHMB), polyaminopropyl biguanide (PAPB), alexidine salts, picloxydine salts or a combination thereof. In certain embodiments, the antimicrobial agent comprises chlorhexidine acetate or PHMB.

The esterification catalyst can facilitate chemical bonding between complementary functional groups, such as between those included in the chitosan conjugate and those included on the surface of the textile. Examples of materials that can be used as esterification catalysts include boron salts, hypophosphite salts (e.g., ammonium hypophosphite and sodium hypophosphite), phosphate salts, tin salts (e.g., salts of Sn⁺² or Sn⁺⁴, such as dibutyl tin dilaurate and dibutyl tin diacetate), and zinc salts (e.g., salts of Zn⁺²). Other examples of materials that can be used as esterification catalysts include metal salts, metal halides, and metal oxides, where suitable metals include Sn, Zn, Ti, Zr, Mn, Mg, B, Al, Cu, Ni, Sb, Bi, Pt, Ca, and Ba. In certain embodiments, the esterification catalyst comprises a Group I or Group II metal (e.g., lithium, sodium, potassium, calcium, etc.) bisulfate, bisulfate, hypophosphite, hypophosphite, or a combination thereof. In certain embodiments, the esterification catalyst comprises sodium hypophosphite.

The present disclosure also provides a coating composition comprising the coating composition precursor described herein and at least one solvent. The solvent is not particularly limited and can be any solvent that the coating composition precursor is at least partially soluble can be used. The solvent can comprise water, alcohol, an ether, or a mixture thereof. Exemplary solvents include, but are not limited to, water, acetone, methanol, ethanol, tetrahydrofuran, tetrahydropyran, and mixtures thereof. In certain embodiments, the solvent comprises water.

In certain embodiments, the coating composition further comprises one or more additives, such as a hydrophilic softener in the form of oil-in-water emulsion composed of silicones, such as polydimethylsiloxane, silicone modified with polyethers, epoxy groups, amino groups, amido groups, methyl hydrogen groups, hydroxyl groups, or mixture thereof; non-ionic softeners such as polyethylene, ethoxylated fatty acid, ethoxylated fatty alcohol, ethoxylated fatty amine, ethoxylated fatty amide, glycerol monostearate, castor oil ethoxylate, or mixture thereof, cationic softeners including quaternary ammonium salts or compounds (quats), ester quaternary ammonium salts or compounds (esterquats), or mixture thereof.

In certain embodiments, the softener comprises a hydrophilic silicone softener, such as amino-modified silicone softener (JX090, Jiangmen Jiaxin Auxillaries Co., Ltd.).

In certain embodiments, the coating composition further comprises one or more excipients, such as dodecyltrimethylammonium (lauryltrimethylammonium) bromide (DTAB), tetradecyltrimethylammonium (myristyltrimethylammonium) bromide (TTAB), cetyltrimethylammonium (hexadecyltrimethylammonium) bromide (CTAB), dodecyltrimethylammonium (lauryltrimethylammonium) chloride (DTAC), tetradecyltrimethylammonium (myristyltrimethylammonium) chloride (TTAC), cetyltrimethylammonium (hexadecyltrimethylammonium) chloride (CTAC), or mixture thereof. In certain embodiments, the excipient is cetyltrimethylammonium bromide (CTAB).

In certain embodiments, the weight ratio of the chitosan conjugate in the coating composition is about 0.01-1%, about 0.01-0.9%, about 0.01-0.8%, about 0.01-0.7%, about 0.01-0.6%, about 0.01-0.5%, about 0.01-0.4%, about 0.01-0.3%, or about 0.01-0.2%. In certain embodiments, the weight ratio of chitosan conjugate in the coating composition is about 0.01-0.2%. In certain embodiments, the weight ratio of the chitosan conjugate in the coating composition is about 0.1%.

In certain embodiments, the weight ratio of the antimicrobial agent in the coating composition is about 0.01-10%, about 0.05-9%, about 0.05-8%, about 0.07-7%, about 0.09-6%, about 0.1-5%, about 0.2-5%, about 0.3-5%, about 0.4-5%, about 0.5-5%, about 0.6-5%, about 0.7-5%, about 0.8-5%, about 0.9-5%, or about 1-5%. In certain embodiments, the weight ratio of the antimicrobial agent in the coating composition is about 0.1-5%. In certain embodiments where the antimicrobial agent comprises chlorhexidine acetate, the weight ratio of the antimicrobial agent in the coating composition is about 1%. In certain embodiments where the antimicrobial agent comprises a polyhexamethylene biguanide, the weight ratio of the antimicrobial agent in the coating composition is about 5%.

In certain embodiments, the weight ratio of the softener in the coating composition is about 1-20%, about 2-20%, about 3-20%, about 4-20%, 5-20%, 6-20%, about 7-20%, about 8-20%, about 5-19%, about 5-18%, about 5-17%, about 5-16%, about 5-15%, about 5-14%, about 5-13%, about 5-12%, about 8-12%, about 9-12%, about 8-11%, or about 9-11%. In certain embodiments, the weight ratio of the softener in the coating composition is about 1-10%. In certain embodiments, the weight ratio of the softener in the coating composition is about 10%.

In certain embodiments, the weight ratio of cetyltrimethylammonium bromide in the coating composition is about 0.01-1%, about 0.01-0.9%, about 0.01-0.8%, about 0.01-0.7%, or about 0.01-0.6%, about 0.01-0.5%, about 0.01-0.4%, about 0.01-0.3%, about 0.01-0.2%, about 0.01-0.1%, about 0.05-0.5%, about 0.05-0.4%, about 0.05-0.3%, about 0.05-0.2%, about 0.08-0.2%, or about 0.01-0.2%. In certain embodiments, the weight ratio of the cetyltrimethylammonium bromide in the coating composition is about 0.01-0.1%. In certain embodiments, the weight ratio of the cetyltrimethylammonium bromide in the coating composition is about 0.1%.

In certain embodiments, the weight ratio of the esterification catalyst in the coating composition is about 0.01-1%, about 0.01-0.9%, about 0.01-0.8%, about 0.01-0.7%, about 0.01-0.6%, about 0.01-0.5%, about 0.01-0.4%, about 0.01-0.3%, about 0.01-0.2%, about 0.01-0.1%, about 0.05-0.5%, about 0.05-0.4%, 0.05-0.3%, 0.05-0.2%, 0.08-0.2%, or 0.01-0.2%. In certain embodiments, the weight ratio of the esterification catalyst in the coating composition can be about 0.01-0.1%. In certain embodiments, the weight ratio of the esterification catalyst in the coating composition can be about 0.1%.

In certain embodiments, the weight ratio of the solvent in the coating composition is about 66-98.96%, 70-98.9%, 75-98.8%, 80-98.8%, 84-98.8%, 84.6-98.7%, 84-98%, 84-95%, 84-92%, 84-90%, 84-89%, 84.6-89%, 84.6-88.8%, or 84.7-88.7%. In certain embodiments, the weight ratio of the solvent in the coating composition can be about 84.6-98.7%. In certain embodiments where the antimicrobial agent comprises chlorhexidine acetate, the weight ratio of the solvent in the coating composition can be about 88.7%. In certain embodiments where the antimicrobial agent comprises polyhexamethylene biguanide, the weight ratio of the solvent in the coating composition is about 84.7%.

The present disclosure also provides a method of preparing a coated textile, the method comprising: contacting a textile with the coating composition thereby forming an uncured coated textile and curing the uncured coated textile thereby forming the coated textile. In certain embodiments, the preparation of the coated textiles comprises pad-dry-cure coating.

In certain embodiments, the curing step is conducted under conditions in which at least a portion of the chitosan conjugate forms a covalent bond with a surface of the textile. The covalent bond between the chitosan conjugate and the surface of the textile can be direct or indirect, e.g. via a connecting compound. In certain embodiments, the connecting compound is a sugar acid.

The textile can be individual staple fibers or filaments, fabrics, yarns, or articles (e.g., garments). Yarns may include, for instance, multiple staple fibers that are twisted together, filaments laid together without twist, filaments laid together with a degree of twist, and a single filament with or without twist. The yarn may or may not be texturized. Suitable fabrics may likewise include, for instance, woven fabrics, knit fabrics, and non-woven fabrics. Garments may be apparel and industrial garments. Fabrics may include home goods, such as linens, drapery, and upholstery (automotive, boating, airline included).

The textile can comprise a cellulosic fiber derived from natural products containing celluloses, such as any one or a combination of wood, bamboo, cotton, banana, piña, hemp ramie, linen, coconut palm, bagasse, kanaf, retting, and the like; semi-synthetic fibers, such as viscose, cuprammonium, rayon, lyocell, cellulose acetate, and the like; and combinations thereof. In certain embodiments, the cellulosic fiber is selected from the group consisting of cotton, linen, hemp, bamboo, jute, flax, and combinations thereof. In certain embodiments, the textile comprises cotton and optionally one or more of polyethylene terephthalate (PET) and spandex.

In certain embodiments, curing comprises heating the uncured coated textile at 120° C. to 160° C., 130° C. to 160° C., 140° C. to 160° C., 150° C. to 160° C., 145° C. to 155° C., 120° C. to 150° C., 130° C. to 150° C., or 140° C. to 150° C. In certain embodiments, curing comprises heating the uncured coated textile at about 150° C.

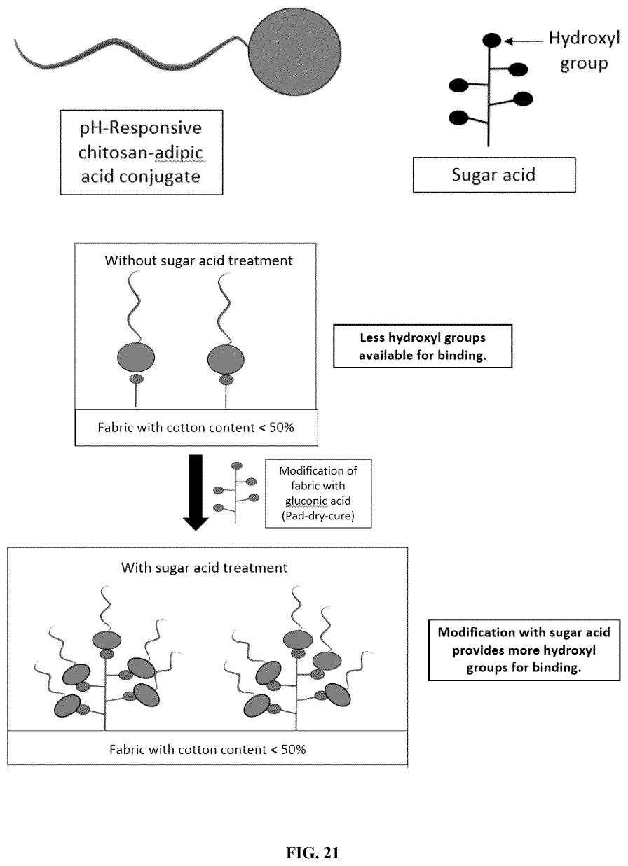

The method of preparing the coated textile can further comprise a pre-treatment step prior to the step of contacting the textile with the coating composition, wherein the pre-treatment step comprises: contacting the textile with a sugar acid and an esterification catalyst, such as sodium hypophosphite, thereby forming an uncured pretreated textile, and curing the uncured pretreated textile under conditions in which at least a portion of the sugar acid forms a covalent bond with a surface of the textile. Advantageously, pre-treatment of the textile with a sugar acid can increase the grafting efficiency of the chitosan conjugate to the surface of the textile (via the hydroxyl groups of the sugar acid). As demonstrated in FIG. 21, pre-treatment of textiles comprising cotton blends (such as cotton and one or more of polyethylene terephthalate and spandex) improves the durability and antimicrobial properties of the coated textile. In certain embodiments, the cotton blend comprising one or more of polyethylene terephthalate and spandex can comprise less than 98%, less than 95%, less than 90%, less than 80%, less than 70%, less than 60%, less than 50%, less than 40%, less than 30% less than 20%, or less than 10% by weight cotton. In certain embodiments, the cotton blend comprising one or more of polyethylene terephthalate and spandex can comprise between 10-98%, 20-98%, 30-98%, 40-98%, 50-95%, 50-90%, 50-80%, 50-70%, or 50-60% by weight cotton.

The sugar can be a monosaccharide with one or more carboxyl groups. The sugar acid can provide more hydroxyl groups on the surface of the textile after the pre-treatment step, which can improve covalent attachment of the chitosan conjugate to the textile. Suitable examples of sugar acids include, but are not limited to, glyceric acid, xylonic acid, gluconic acid, ketodeoxyoctulosonic acid, galacturonic acid, iduronic acid, tartaric acid, mucic acid, saccharic acid, etc. In certain embodiments, the sugar acid is gluconic acid.

Also provided is a coated textile comprising a textile and the coating composition precursor described herein disposed on a surface of the textile.

The textile can be individual staple fibers or filaments, fabrics, yarns, or articles (e.g., garments). Yarns may include, for instance, multiple staple fibers that are twisted together, filaments laid together without twist, filaments laid together with a degree of twist, and a single filament with or without twist. The yarn may or may not be texturized. Suitable fabrics may likewise include, for instance, woven fabrics, knit fabrics, and non-woven fabrics. Garments may be apparel and industrial garments. Fabrics may include home goods, such as linens, drapery, and upholstery (automotive, boating, airline included).

The textile can comprise a cellulosic fiber derived from natural products containing celluloses, such as any one or a combination of wood, bamboo, cotton, banana, piña, hemp ramie, linen, coconut palm, bagasse, kanaf, retting, and the like; semi-synthetic fibers, such as viscose, cuprammonium, rayon, lyocell, cellulose acetate, and the like; and combinations thereof. In certain embodiments, the cellulosic fiber is selected from the group consisting of cotton, linen, hemp, bamboo, jute, flax, and combinations thereof. In certain embodiments, the textile comprises cotton and optionally one or more of polyethylene terephthalate (PET) and spandex.

In certain embodiments, at least a portion of the chitosan conjugate forms a covalent bond with the surface of the textile. In certain embodiments, the covalent bond is formed between the carboxylic acid present in R¹ and hydroxyl groups present on the surface of the textile.

In certain embodiments, coated textile exhibits at least 90%, at least 95%, at least 96%, at least 97%, at least 98%, at least 99%, at least 99.9%, at least 99.99%, of greater antimicrobial effect against one or more microbes selected from the group consisting of a bacteria, a virus, a combination thereof after 1, 2, 3, 4, 5, 6, 7, 8, 9, or 10 laundry cycles (equivalent to 5, 10, 15, 20, 25, 30, 35, 40, 45, or 50 home laundry cycles) conducted in accordance with AATCC 61-2A. In certain embodiments, 90-99.99%, 95-99.99%, 96-99.99%, 97-99.99%, 98-99.99%, 99-99.99%, 90-99%, 90-98%, 90-97%, 90-96%, 90-95%, 90-94%, 90-93.4%, 91-93.4%, or 92-93.4% antimicrobial effect against one or more microbes selected from the group consisting of a bacteria, a virus, a combination thereof after 1-10, 2-10, 3-10, 4-10, 5-10, 6-10, 7-10, 8-10, or 9-10 laundry cycles (equivalent to 5-50, 10-50, 15-50, 20-50, 25-50, 30-50, 35-50, 40-50, or 45-50 home laundry cycles) conducted in accordance with AATCC 61-2A.

The AATCC 61-2A protocol has the following specifications:
1. 0.23% Laundry Detergent (e.g., Tide® Simply Free & Sensitive Unscented™ Laundry Detergent).
2. 50 steel balls per canister.
3. 49° C.
4. 500 mL detergent solution per canister.
5. 10 grams of fabric (or roughly a 8″×8″ sample).
6. One 45-minute cycle (represents 5 home launderings).
7. After each cycle, samples are hand rinsed in cold tap water (30 seconds), hand wrung and either dried in standard oven or air dried depending on sample composition.

The present disclosure also provides a method of preparing the coating composition precursor, the method comprising combining the antimicrobial agent, the esterification catalyst, and the chitosan conjugate thereby forming the coating composition.

In certain embodiments, the coating composition can be prepared by combining the coating composition precursor and the solvent; or combining the antimicrobial agent; the esterification catalyst, the chitosan conjugate, and the solvent.

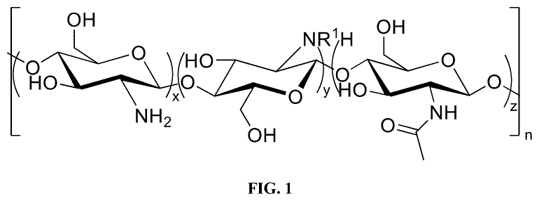

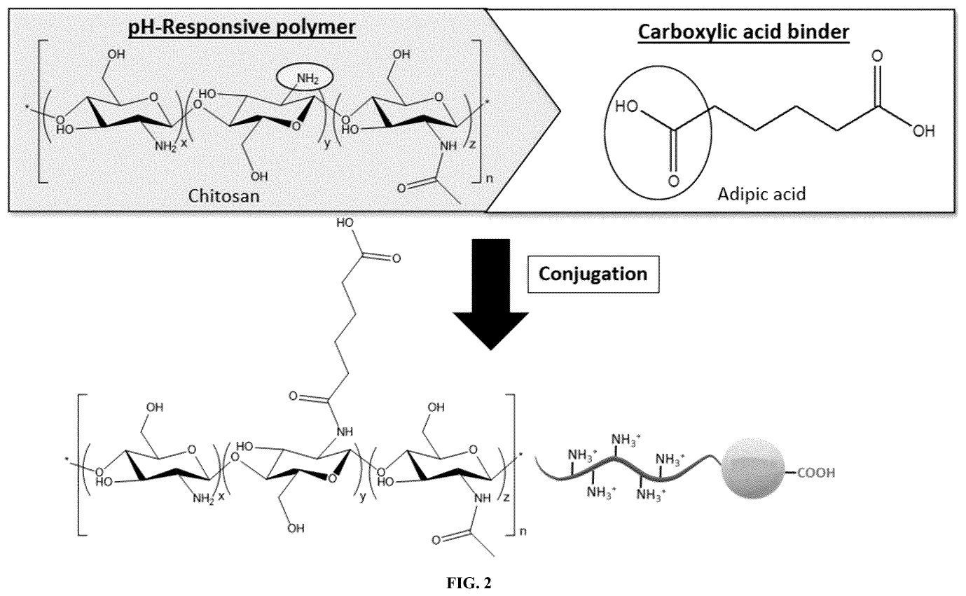

The chitosan conjugate (FIG. 1) described herein can be readily prepared using well known methods in the art. In certain embodiments, the chitosan conjugate is prepared by coupling chitosan with a dicarboxylic acid using a coupling agent and optionally a coupling agent additive. FIG. 2 depicts an embodiment of coupling chitosan and adipic acid thereby forming chitosan-adipic acid conjugate.

The chitosan can have an average molecular weight of 100,000-300,000 g/mol or 180,000-260,000 g/mol. The degree of deacetylation of the chitosan can range from 50-100%, 70-100%, 80-100%, or 80-95%.

The dicarboxylic acid can be represented by the chemical formula HO₂C(CH₂)ₘCO₂H, wherein m is a whole number selected from 1-12. In certain embodiments, the dicarboxylic acid is malonic acid (propanedioic acid), succinic acid (butanedioic acid), or glutaric acid (pentanedioic acid), or adipic acid (hexanedioic acid), or pimelic acid (heptanedioic acid), suberic acid (octanedioic acid), sebacic acid (decanedioic acid), undecanedioic acid, dodecanedioic acid, brassylic acid (tridecanedioic acid), or a combination thereof.

The coupling agent can be a carbodiimide, such as DCC, DIC, EDC, CIC, BMC, CPC, BDDC, PIC, PEC, and BEM, a uronium/aminium salt, such as HATU, HBTU, TATU, TBTU, TSTU, HAPyU, TAPipU, HAPipU, HBPipU, HAMBU, HBMDU, HAMTU, 5,6-B(HATU), 4,5-B(HATU), HCTU, TCTU, and ACTU, phosphonium salts, such as AOP, BOP, PyAOP, PyBOP, PyOxm, PyNOP, PyFOP, NOP, and PyClock, immonium salts, such as DMTMM, BOMI, BDMP, BMMP, BPMP, and AOMP. In certain embodiments, the coupling agent is selected from the group consisting of TATU, TSTU, TBTU, DIC, EDC, BDDC and DMTMM.

The coupling additive can be any coupling additive known in the art, such as HOBt, 6-NO₂—HOBt, 6-Cl—HOBt, 6-CF₃—HOBt, HOAt, HODhbt, HODhat, NHS, HONHS, Sulfo-NHS, and Oxyma. In certain embodiments, the coupling additive is selected from the group consisting of HOBt, HOAt, NHS and sulfo-NHS.

In certain embodiments, the coupling agent is EDC or DMTMM and the optional coupling additive is NHS or Sulfo-NHS. FIG. 3 depicts the coupling reaction of adipic acid with chitosan using EDC and Sulfo-NHS. FIG. 9 depicts the coupling reaction of adipic acid with chitosan using DMTMM.

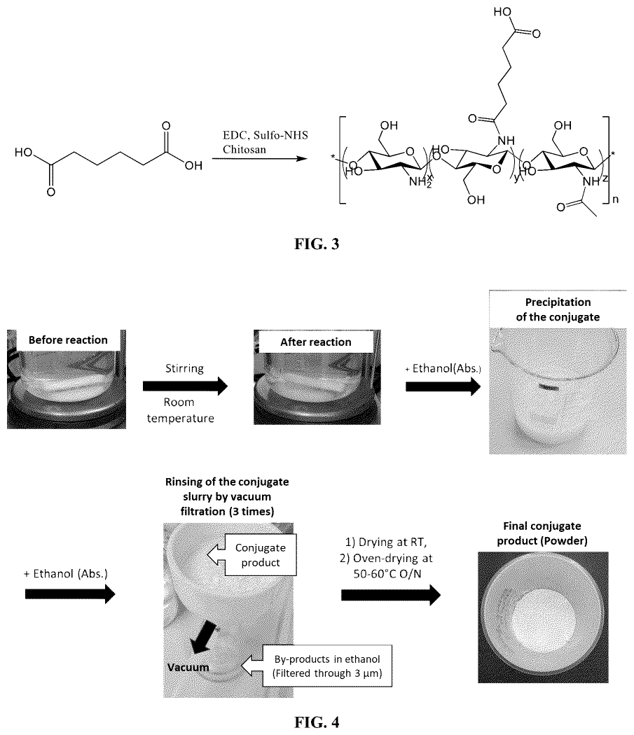

The coupling reaction between chitosan and the dicarboxylic acid can be conducted in any polar protic or aprotic solvent. In certain embodiments, the coupling reaction solvent is water, alcohols, ketones, ethers, haloalkanes, or combinations thereof. In certain embodiments, the solvent comprises water, dichloromethane, 1,2-dichloroethane, chloroform, tetrahydrofuran, diethyl ether, acetone, 1,4-dioxane, acetonitrile, ethyl acetate, propylene carbonate, ethanol, isopropanol, and combinations thereof. As shown in FIG. 4, when the coupling reaction between chitosan and the dicarboxylic acid is conducted in water, the chitosan conjugate can readily be obtained by precipitation with ethanol and isolation of the chitosan conjugate by filtration.

### Example 1-Preparation of Chitosan-Adipic Acid Conjugate by EDC-NHS Carbodiimide-Mediated Coupling Reaction

### 1.1 Experimental Procedures

Adipic acid was dissolved in water and the pH of the solution was adjusted to 5.5-6. 1-(3-dimethylaminopropyl)-3-ethylcarbodiimide hydrochloride (EDC·HCl) and N-hydroxysulfosuccinimide (Sulfo-NHS) were added to the adipic acid solution and mixed at room temperature for 15 minutes to activate the carboxyl groups on adipic acid. Immediately after the carboxyl activation, chitosan (degree of deacetylation=80-95%) was added to the solution and the reaction was stirred at room temperature overnight (FIG. 3). The mole equivalent of dicarboxylic acid was in excess of coupling agent, preferably 2-4-fold in excess, and more preferably, 2.5-3.5-fold in excess. Experimental details were summarized in Table 1. The formed chitosan-adipic acid conjugate was purified and obtained from ethanol precipitation. Acetone, isopropanol, or methanol were also applicable for purification of precipitation. The resulting residues were dried at room temperature, followed by 50-60° C. to obtain a white powder (FIG. 4). Reaction EP1306-28 resulted in 1.4% yield of chitosan-adipic acid conjugate. The yield increased to 2.8% when doubling the amount of chitosan and adipic acid in reaction EP1306-53 using the same synthetic method as above.

TABLE 1
The wt. % of reactants in the preparation of chitosan-adipic
acid conjugate, reactions EP1306-28 and EP1306-53

| Reaction # | Chitosan (%) | Adipic acid (%) | EDC · HCl (%) | Sulfo-NHS (%) | Water (%) |
|---|---|---|---|---|---|
| EP1306-28 | 1.0 | 0.8 | 0.6 | 1.2 | 96.4 |
| EP1306-53 | 2.0 | 1.6 | 0.6 | 1.2 | 94.6 |

### 1.2 Elucidation of the Resulting Chitosan-Adipic Acid Conjugate

The purified chitosan-adipic acid conjugate was characterized by Attenuated total reflectance-Fourier transform infrared (ATR-FTIR) spectroscopy. FIG. 5 shows the FTIR spectra of adipic acid, chitosan, and chitosan-adipic acid conjugate. Successful grafting of adipic acid to chitosan was evident by the presence of C═O stretch at 1655 cm⁻¹ and amide N—H bending at 1528 cm⁻¹ on the spectrum of the conjugate. In comparison with C═O signals at 1685 cm⁻¹ and N—H signal at 1590 cm⁻¹ from unreacted adipic acid and chitosan, respectively, the C═O stretch and amide NH bend signals from the chitosan-adipic acid conjugate demonstrated shifting to lower wavenumbers from corresponding peaks. The shifting of the signals suggested the formation of the conjugate from the starting materials, adipic acid and chitosan.

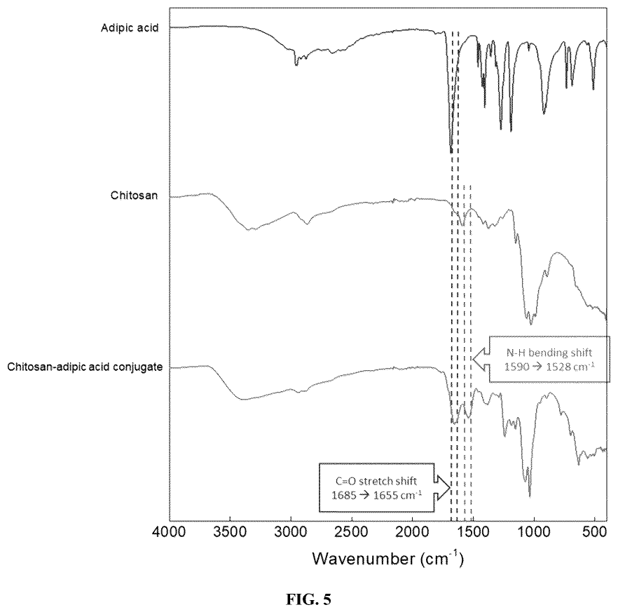

Molecular weight distribution of the synthesized chitosan-adipic acid conjugate was determined by size-exclusion chromatography (SEC) (Agilent 1260 Infinity). Dextran standards were used to calibrate the SEC instrument. Chitosan and chitosan-adipic acid conjugate samples were injected into Ultrahydrogel Linear column (Waters) and eluted with 0.5 M acetic acid at flow rate 1.0 mL/min at 30° C. The eluted samples were detected by refractive index (RI) detector and shown in FIG. 6. The molecular weight distribution was determined in terms of number average molecular weight (Mₙ), weight average molecular weight (M_{w}) and polydispersity index (PDI).

Table 2 summarizes the molecular weight distribution of chitosan and chitosan-adipic acid conjugate. The degree of polymerization (DP) of chitosan was estimated to be 1,000 from Mn value, where the chitosan was composed of 800-950 D-glucosamine units and 50-200 acetyl-D-glucosamine units. Taking the number of D-glucosamine units into account, the amount of primary amino groups was estimated to be 800-950. Conjugation of adipic acid to chitosan showed an increase in M_{w} for 10,000 g/mol, which was equivalent to grafting 68 molecules of adipic acid per chitosan chain. The increase in the molecular weight also suggested no covalent inter-crosslinking between chitosan chains was observed, which would result in two-fold or more increase in the molecular weight distribution of the conjugate, as well as bimodal or multimodal molecular weight distribution on the SEC trace. Assuming one of the carboxyl groups on each adipic acid molecule was activated by EDC·HCl coupling agent, the conjugation efficiency was 16-17%, with a grafting degree of 7-8.3%. The resulting chitosan-adipic acid conjugates could be represented by the Formula IV, where x is 13, y is 1, z is 0.7, n is 68 (molar ratio of Formula I is 6.8%); or x is 11, y is 1, z is 3, n is 68 (molar ratio of Formula I is 6.67%), and R¹ is —(C═O) (CH₂)₄CO₂H.

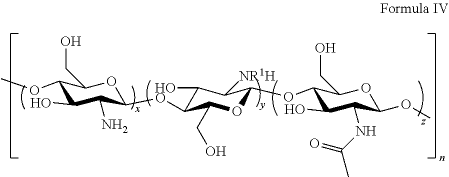

TABLE 2
Molecular weight distribution of chitosan and chitosan-adipic
acid conjugate prepared by EDC-NHS carbodiimide coupling

| Molecular weight | | |
|---|---|---|
| distribution | Chitosan | Chitosan-adipic acid conjugate |
| Mₙ (g/mol) | 180,000 | 180,000 |
| M_{w} (g/mol) | 260,000 | 270,000 |
| PDI | 1.44 | 1.54 |

### 1.3 Solubility Test

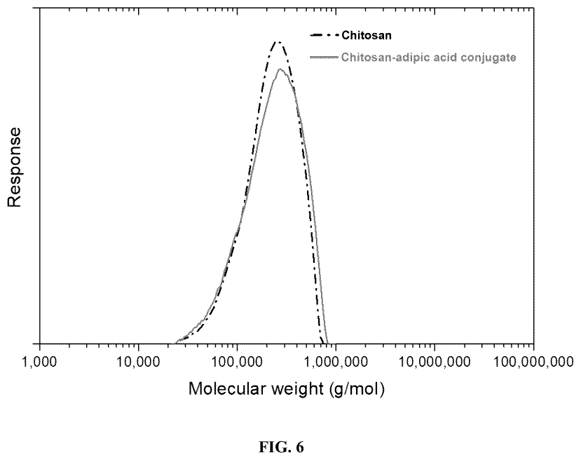

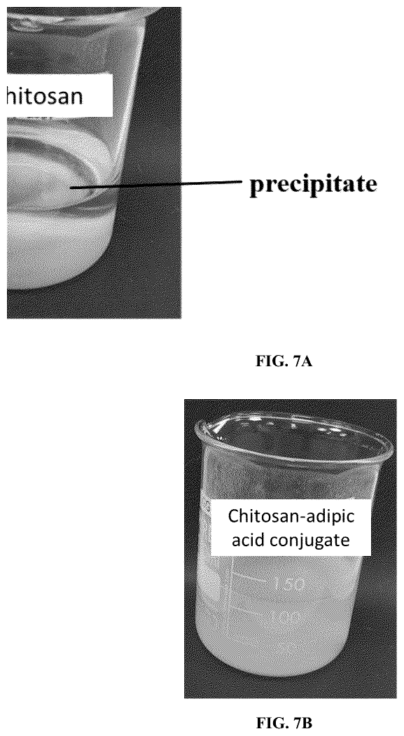

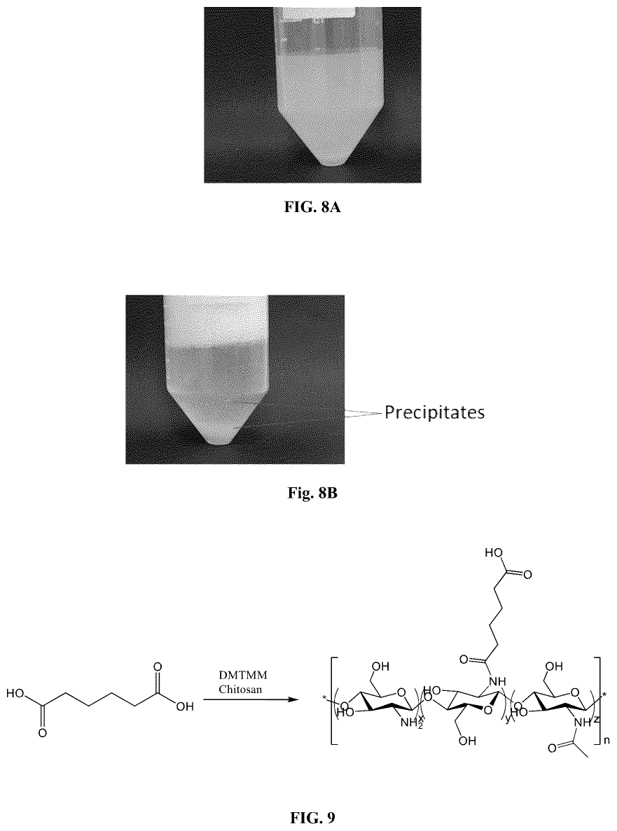

The as-developed chitosan conjugate advantageously exhibited an improvement in water compatibility, which would be applicable for development of stable water-based formulation. Before reaction, chitosan was insoluble in water (FIG. 7A). When the chitosan was chemically modified with adipic acid, the formed conjugate was able to disperse in water (FIG. 7B). The resulting chitosan conjugate is soluble in water and aqueous solution of pH<7, preferably at a concentration of 0.01-2.5%, more preferably, 0.01%-0.1% The resulting chitosan conjugate remains insoluble in aqueous solution of pH>7. When laundry detergent was added to the conjugate dispersion, the conjugate was found to precipitate out and settled to the bottom (FIGS. 8A and 8B), demonstrating the pH-responsiveness of the conjugate. The pH switchable feature enables the conjugate to be delivered to fabrics in an aqueous-based solutions.

### Example 2-Preparation of Chitosan-Adipic Acid Conjugate by DMTMM Coupling Reaction

### 2.1 Experimental Procedures

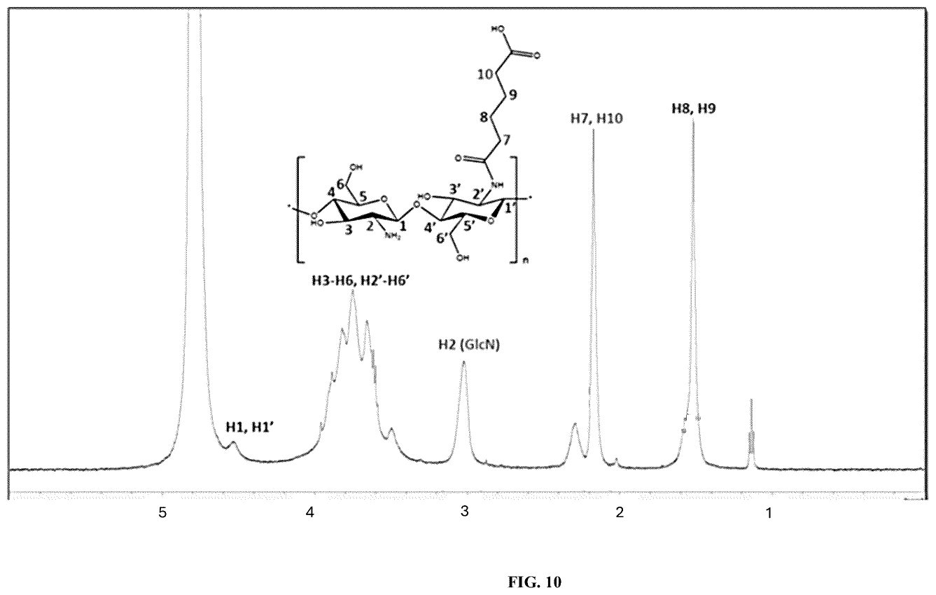

Chitosan (Degree of deacetylation=80-95%), adipic acid and 4-(4,6-dimethoxy-1,3,5-triazin-2-yl)-4-methyl-morpholinium chloride (DMTMM) were dissolved in water and stirred at room temperature for 4 hours (FIG. 9). The mole equivalent of dicarboxylic acid was in excess of coupling agent, preferably 2-4-fold in excess, and more preferably, 2.5-3.5-fold in excess. Experimental details were summarized in Table 3. The formed chitosan-adipic acid conjugate was purified and obtained from ethanol precipitation. Acetone, isopropanol, or methanol were also applicable for purification of precipitation. The resulting resides were dried at room temperature, followed by 50-60° C. to obtain a white powder (FIG. 4). The chitosan-adipic acid conjugate was obtained at a yield of 2.4%. 1H-NMR (500 MHZ, D₂O): δ (ppm) 1.51 (s, 4H, adipic acid [CH₂CH₂] backbone), 2.17 (s, 4H, adipic acid CH₂ groups), 3.02 (s, 1H, —CH—NH₂ GlcN backbone), 3.49-3.88 (m, 5H, GlcN and conjugated GlcN backbone), 4.53 (m, 1H, glycosides with D₂O) (FIG. 10).

TABLE 3
The wt. % of reactants in preparation of chitosan-
adipic acid conjugate, reaction EP1306-82b

| | | Adipic | | |
|---|---|---|---|---|
| Reaction # | Chitosan (%) | acid (%) | DMTMM (%) | Water (%) |
| EP1306-82b | 2.0 | 2.4 | 1.6 | 94 |

### 2.2 Elucidation of the Resulting Chitosan-Adipic Acid Conjugate

The purified chitosan-adipic acid conjugate was characterized by Attenuated total reflectance-Fourier transform infrared (ATR-FTIR) spectroscopy. FIG. 11 shows the FTIR spectrum of adipic acid, chitosan, and chitosan-adipic acid conjugate (The acetylated-glucosamine unit on chitosan and chitosan-adipic acid conjugate are not presented). Successful grafting of adipic acid to chitosan was evident by the presence of C═O stretch at 1633 cm⁻¹ and amide N—H bending at 1541 cm⁻¹ on the spectrum of the conjugate. In comparison with C═O signals at 1685 cm⁻¹ and N—H signal at 1590 cm⁻¹ from unreacted adipic acid and chitosan, respectively, the C═O stretch and amide NH bend signals from the conjugate demonstrated shifting to lower wavenumbers from corresponding peaks. The shifting of the signals suggested the formation of the conjugate from the starting materials.

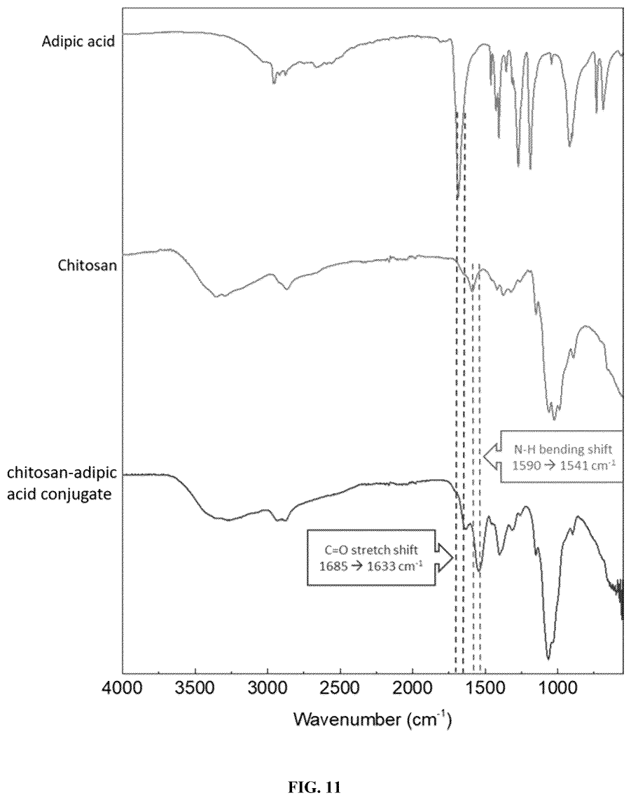

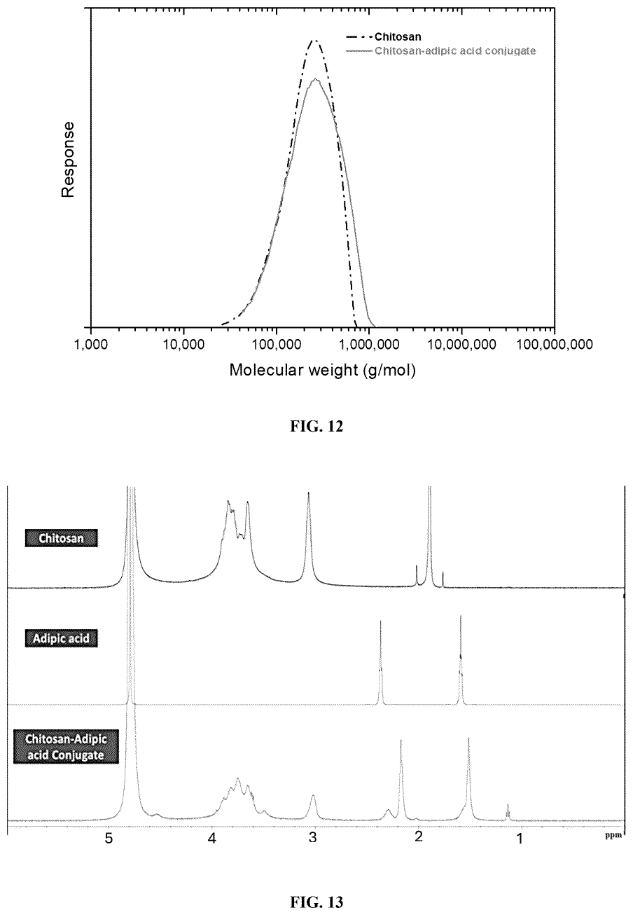

The molecular weight distribution of the synthesized chitosan-adipic acid conjugate was determined by size-exclusion chromatography (SEC). Dextran standards were used to calibrate the SEC instrument. Chitosan and chitosan-adipic acid samples were injected into Ultrahydrogel Linear column (Waters) and eluted with 0.5 M acetic acid at flow rate 1.0 mL/min at 30° C. The eluted samples were detected by refractive index (RI) detector (FIG. 12). The molecular weight distribution was determined in terms of number average molecular weight (Mₙ), weight average molecular weight (M_{w}) and polydispersity index (PDI).

Table 4 summarizes the molecular weight distribution of chitosan and chitosan-adipic acid conjugate. The degree of polymerization (DP) of chitosan was estimated to be 1,000 from Mₙ value, where the chitosan was composed of 800-950 D-glucosamine units and 50-200 acetyl-D-glucosamine units. Taking the number of D-glucosamine units into account, the amount of primary amino groups was estimated to be 800-950. Conjugation of adipic acid to chitosan showed an increase in M_{w} for 40,000 g/mol, which was equivalent to grafting 274 molecules of adipic acid per chitosan chain. Such increase in the molecular weight also suggested no covalent inter-crosslinking between chitosan chains was observed, which would result in two-fold or more increase in the molecular weight distribution of the conjugate, as well as bimodal or multimodal molecular weight distribution on the SEC trace. Assuming one of the carboxyl groups on each adipic acid molecule was activated by DMTMM coupling agent, the conjugation efficiency was 36%, with a grafting degree of 28-34%.

TABLE 4
Molecular weight distribution of chitosan and chitosan-adipic
acid conjugate prepared by DMTMM coupling reaction

| Molecular weight | | |
|---|---|---|
| distribution | Chitosan | Chitosan-adipic acid conjugate |
| Mₙ (g/mol) | 180,000 | 200,000 |
| M_{w} (g/mol) | 260,000 | 300,000 |
| PDI | 1.44 | 1.52 |

The NMR spectrum of the chitosan-adipic acid conjugate showed a shift to lower ppm compared with chitosan and adipic acid. Peak shape at 3.49-3.88 ppm (N-glucosamine backbone) of the conjugate appeared to be different from that of N-glucosamine backbone of chitosan at 3.65-3.84 ppm. The changes and shifting of NMR signals suggested adipic acid was covalently attached to chitosan on the conjugate (FIG. 13). The resulting chitosan-adipic acid conjugates could be represented by the Formula IV, where x is 2-3, y is 1, z is 0.2, n is 274 (molar ratio of Formula I is 23.81%-31.25%); or x is 2, y is 1, z is 0.7, n is 274 (molar ratio of Formula I is 27%), and R¹ is —(C═O) (CH₂)₄CO₂H.

The grafting degree of adipic acid to chitosan was determined by integration of NMR spectrum of the conjugate. The ratio between peak area at 3.02 ppm (GlcN, H2 on chitosan) and peak area at 2.17 ppm (conjugated adipic acid CH₂ groups) was 1:1.3384. The ratio was calculated as 1:0.33 (chitosan:adipic acid moiety) after the peak area was divided by the respective number of protons, which equaled to the ratio of NH₂ group and conjugated adipic acid (3:1). The result suggested a grafting degree of 25% for adipic acid (FIG. 10). The grafting degree determined by the NMR spectrum correlated with the estimation of grafting degree calculated by molecular weight distribution according to SEC.

### 2.3 Solubility Test

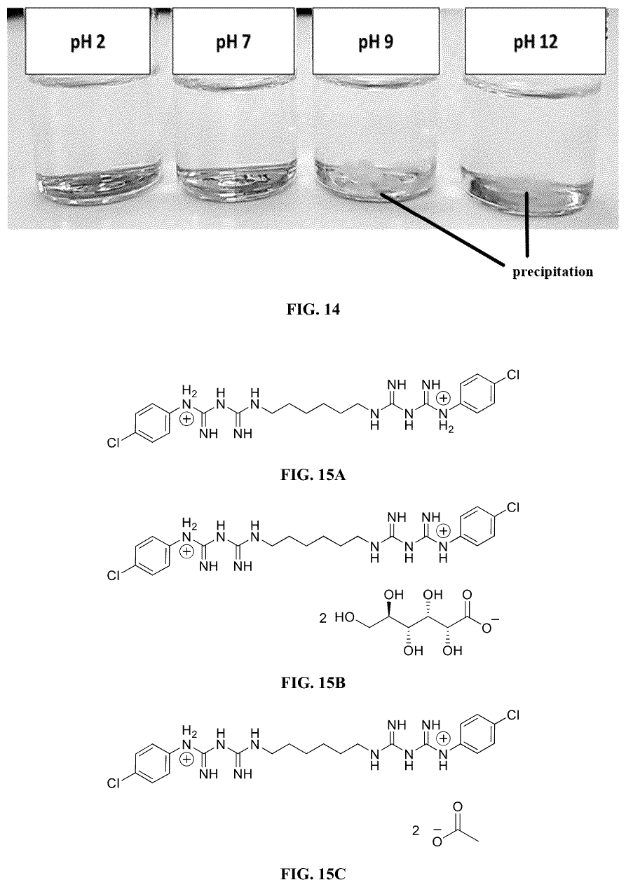

The as-developed chitosan-adipic acid conjugate advantageously exhibited an improvement in water compatibility, which would be applicable for development of stable water-based formulation. The resulting chitosan conjugate is soluble in water and aqueous solution of pH<7, preferably at a concentration of 0.01-2.5%, more preferably, 0.01%-0.1% The resulting chitosan conjugate remains insoluble in aqueous solution of pH>7. The conjugate was completely soluble in water and acidic aqueous at pH=2 but became insoluble in alkaline aqueous at pH=9 and pH=12 (FIG. 14). The pH switchable feature enables the conjugate to be delivered to fabrics in a water-based antimicrobial coating composition along, further forming a protective film layer for the antimicrobial agents.

### Example 3—Selection of Suitable Antimicrobial Agents

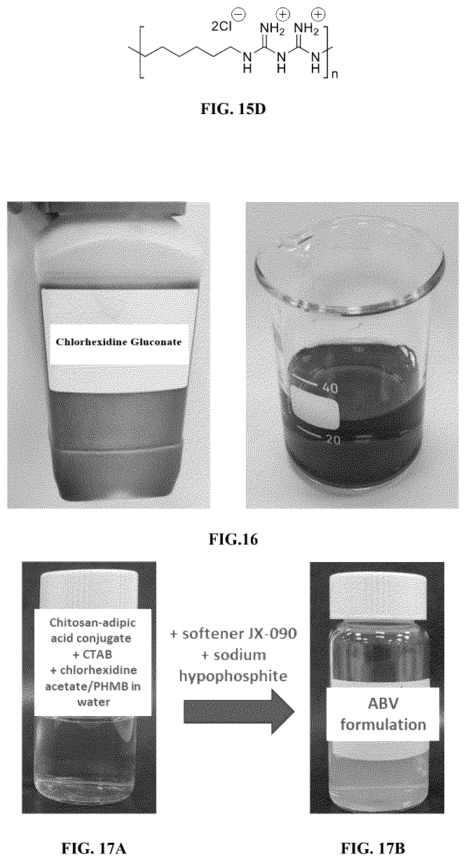

Chlorhexidine, chlorhexidine salts and polyhexamethylene biguanide (PHMB) were explored as antimicrobial agents for the development of pH-responsive antibacterial and antiviral (ABV) coating composition. Chlorhexidine, chlorhexidine gluconate, chlorhexidine acetate and PHMB (FIGS. 15A-15D) were studied in terms of the solubility in aqueous solution, the stability, and the compatibility with the coating composition. Solubilization of chlorhexidine in water required acetic acid component to give clear solution. However, the presence of acid in the solution left an acidic odor on coated fabric, even after curing at high temperature. Chlorhexidine gluconate was then explored for the development of the coating composition due to good water solubility without addition of acidic component. However, FIG. 16 shows chlorhexidine gluconate (20 wt. % in aqueous solution) turned dark brown in color over time, so it would affect the color stability of final coated fabrics. Chlorhexidine acetate and PHMB were finally chosen as antimicrobial agents for the formulation development. They demonstrated good water solubility and compatibility with formulation and were odorless on coated fabrics. Furthermore, both chlorhexidine acetate and PHMB existed in solid form, which were preferable for stable storage.

### Example 4—Preparation of Coating Compositions (Hereinafter Referred to as ABV Formulations) with Chlorhexidine Acetate

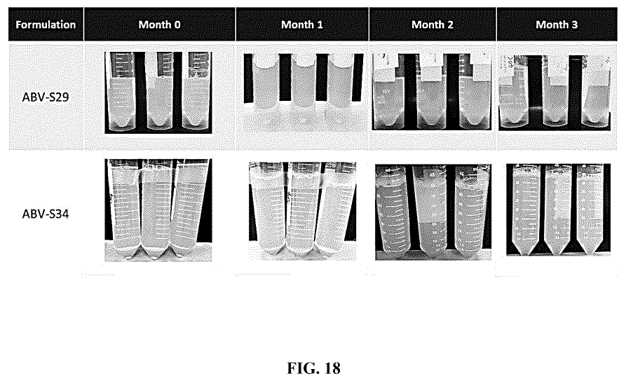

The ABV formulation was prepared by mixing the synthesized chitosan-adipic acid conjugate, chlorhexidine acetate, cetyltrimethylammonium bromide (CTAB), sodium hypophosphite and hydrophilic silicone softener JX090 in water. CTAB was chosen as an excipient for the formulation as it improved the solubility of chitosan-adipic acid conjugate in water. Sodium hypophosphite was selected as the catalyst for binding between the carboxyl ends (—COOH) on the chitosan-adipic acid conjugate and the hydroxyl (—OH) moieties on cotton through heat-induced esterification in fabric curing. Optimization of the formulation was carried out by mixing different ratios of the above ingredients. When only 1 wt. % softener was introduced into the formulations, the coated fabrics were found to have reduced softness compared with fabrics coated with softener only. Increasing the softener content to 10 wt. % in the formulation provided satisfying hand feel in softness of the fabrics. Chitosan-adipic acid conjugates were also soluble in water without purification (shown in the second photo labeled after reaction in FIG. 4) for formulation development. Nevertheless, the conjugate solution imparted a certain extent of color to the coated textiles as well as increasing the stiffness of the coated fabrics. The formulation was optimized in ABV-S29 (Table 5), which was composed of purified chitosan-adipic acid conjugate, 10 wt. % softener, with an increased amount of chlorhexidine acetate. Addition of chlorhexidine acetate and CTAB to chitosan-adipic acid conjugate in water was observed to give a homogeneous clear solution (FIG. 17A). The solution turned to translucent when hydrophilic softener JX-090 and sodium hypophosphite was added (FIG. 17B).

TABLE 5
Different pH-responsive ABV formulations optimized with different concentrations
of chitosan-adipic acid conjugate, chlorhexidine acetate, catalyst, and softener

| | | | | | | Hydrophilic |
|---|---|---|---|---|---|---|
| | Chitosan- | | | | | silicone |
| | Adipic Acid | Chlorhexidine | | Sodium | | softener |
| | Conjugate | acetate | CTAB | hypophosphite | Water | JX-090 |
| Formulation # | (wt. %) | (wt. %) | (wt. %) | (wt. %) | (wt. %) | (wt. %) |
| ABV-S24 | 0.1 (Purified) | 0.5 | 0.1 | 0.1 | 98.2 | 1 |
| ABV-S25 | 10 (Solution | 0.5 | 0.1 | 0.1 | 88.3 | 1 |
| | without | | | | | |
| | purification) | | | | | |
| ABV-S27 | 20 (Solution | 0.5 | 0.1 | 0.2 | 69.2 | 10 |
| | without | | | | | |
| | purification) | | | | | |
| ABV-S29 | 0.1 (Purified) | 1 | 0.1 | 0.1 | 88.7 | 10 |

### Example 5—Preparation of Coating Compositions (Hereinafter Referred to as ABV Formulations) with Polyhexamethylene Biguanide (PHMB)

The ABV formulation was prepared by mixing the purified chitosan-adipic acid conjugate from synthesis, polyhexamethylene biguanide (PHMB), cetyltrimethylammonium bromide (CTAB), sodium hypophosphite and hydrophilic silicone softener JX090 in water. CTAB was chosen as an excipient for the formulation as it improved the solubility of chitosan-adipic acid conjugate in water. Sodium hypophosphite was selected as the catalyst for binding a portion of chitosan-adipic acid conjugate to the textiles between the carboxyl ends (—COOH) on the chitosan-adipic acid conjugate and the hydroxyl (—OH) moieties on the textiles through a heat-induced esterification during textiles curing. Optimization of the formulation was carried out by increasing the concentration of PHMB. The formulation was optimized in ABV-S34 (Table 6), which provided a more significant antimicrobial effect as a coating on fabrics. Addition of chlorhexidine acetate and CTAB and sodium hypophosphite to chitosan-adipic acid conjugate in water was observed to give a homogeneous clear solution (FIG. 17A). The solution turned translucent when hydrophilic softener JX-090 and sodium hypophosphite was added (FIG. 17B).

TABLE 6
Different pH-responsive ABV formulations optimized with different concentrations of PHMB

| | Chitosan- | | | | | Hydrophilic |
|---|---|---|---|---|---|---|
| | adipic | Polyhexamethylene | | | | silicone |
| | acid | biguanide | | Sodium | | softener |
| | conjugate | (PHMB) | CTAB | hypophosphite | Water | JX-090 |
| Formulation # | (wt. %) | (wt. %) | (wt. %) | (wt. %) | (wt. %) | (wt. %) |
| ABV-S32 | 0.1 | 1 | 0.1 | 0.1 | 88.7 | 10 |
| | (Purified) | | | | | |
| ABV-S33 | 0.1 | 2 | 0.1 | 0.1 | 87.7 | 10 |
| | (Purified) | | | | | |
| ABV-S34 | 0.1 | 5 | 0.1 | 0.1 | 84.7 | 10 |
| | (Purified) | | | | | |

### Example 6—Evaluation of Antibacterial Performance of Coating Compositions (Hereinafter Referred to as ABV Formulations)

The antibacterial performance of pH-responsive ABV formulation ABV-S29 and ABV-S34 were evaluated using dilution-neutralization method of industrial standard BS EN 1276. Briefly, ABV-S29 formulation was mixed with tryptic soy broth (TSB) suspension of Staphylococcus aureus (S. aureus.) at a concentration of 10⁸-10⁹ cfu/mL and Escherichia coli (E. coli.) at a concentration of 10⁹ cfu/mL for one minute. At the end of the mixing, Dey/Engley (D/E) neutralizing broth was mixed with the bacterial incubation solution for 1 minute to neutralize the antibacterial action of the ABV formulation. The D/E neutralized incubation solution was serial-diluted by phosphate-buffered saline (PBS) and cultured on tryptic soy agar (TSA) plates, which were incubated at 37° C. for 18-24 hours. The bacterial colonies formed on the agar plates were quantified and compared with bacterial colonies obtained from bacterial incubation with 10% hydrophilic softener JX090 solution, which served as the control group. The percent reduction (%) calculated according to Equation 1 is used to refer to the antibacterial performance of the ABV formulations. Equation 1 is as follows:

$$Percent reduction ( \% ) = \frac{( A - B )}{A} \times 100$$

A=Bacteria recovered from 10% softener only (cfu)
B=Bacteria recovered from ABV softener formulation (cfu)
   Equation 1

Table 7 and Table 8 summarize the average number of bacterial colonies recovered from solution containing 10% softener (the control group) and ABV formulations. Both ABV-S29 and ABV-S34 formulations demonstrated over 99.999% antibacterial effect against S. aureus. and over 99.99999% antibacterial effect against E. coli.

TABLE 7
The antibacterial performance of ABV
formulations against S. aureus

| | Bacteria | Bacteria | |
|---|---|---|---|
| | recovered from | recovered from | Percent |
| | 10% softener (Control) | ABV formulations | reduction |
| Formulation | (CFU) | (CFU) | (%) |
| ABV-S29 | 4.80E+07 | <100 | >99.999 |
| ABV-S34 | 5.10E+08 | <100 | >99.9999 |

TABLE 8
The antibacterial performance of ABV formulations against E. coli

| | Bacteria | Bacteria | |
|---|---|---|---|
| | recovered from | recovered from | Percent |
| | 10% softener (Control) | ABV formulations | reduction |
| Formulation | (CFU) | (CFU) | (%) |
| ABV-S29 | 1.18E+09 | <100 | >99.99999 |
| ABV-S34 | 1.17E+09 | <100 | >99.99999 |

### Example 7—Safety Evaluation of Coating Compositions (Hereinafter Referred to as ABV Formulations)

Safety of pH-responsive formulation ABV-S29 and ABV-S34 was evaluated by accredited laboratories (Intertek Testing Services HK Ltd.). Safety assessment including REACH Substances of Very High Concern (SVHC) testing, the detection of the total content of 17 (heavy) metals and the detection of 22 phthalates, was performed and summarized in Table 9. The formulations, ABV-S29 and ABV-S34, passed the safety tests, which the remaining heavy metal and phthalate met OEKO-TEX requirements.

TABLE 9
Safety tests for ABV-S29 and ABV-S34 formulations

| Safety | SVHC | Heavy metal | Phthalates |
|---|---|---|---|
| Tests | screening | screening | screening |
| Screening | 233-235 | Antimony (S) | Benzylbutylphthalate |
| substances | Chemicals | Arsenic (As) | Dibutylphthalate |
| | | Lead (Pb), | Diethylphthalate |
| | | Cadmium (Cd) | Dimethylphthalate |
| | | Chromium (Cr) | Di-(2-ethylhexyl)phthalate |
| | | Hexavalent | Di-(2-methoxyethyl)phthalate |
| | | Chromium (CrVI) | Di-C6-8-branched |
| | | Cobalt (Co) | alkylphthalates, C7 rich |
| | | Copper (Cu) | Di-C7-11-branched and |
| | | Nickel (Ni) | linear alkylphthalates |
| | | Mercury (Hg) | Dicyclohexylphthalate |
| | | Silver (Ag), | Dihexylphthalates, |
| | | Barium (Ba) | branched and linear |
| | | Iron (Fe) | Di-iso-butylphthalate |
| | | Manganese (Mn) | Di-iso-hexylphthalate |
| | | Selenium (Se) | Di-iso-octylphthalate |
| | | Tin (Sn) | Di-iso-nonylphthalate |
| | | Zinc (Zn) | Di-iso-decylphthalate |
| | | | Di-n-propylphthalate |
| | | | Di-n-hexylphthalate |
| | | | Di-n-octylphthalate |
| | | | Di-n-nonylphthalate |
| | | | Di-n-pentylphthalate (n-, iso, |
| | | | or mixed) |
| | | | 1,2-Benzenedicaboxylic |
| | | | acid, di-C6-10 alkyl esters |
| | | | 1,2-Benzenedicarboxylic |
| | | | acid, mixed decyl |
| | | | and hexyl and |
| | | | octyl diesters |
| Results for | Passed | Passed | Passed |
| ABV-S29 | | | |
| Results for | Passed | Passed | Passed |
| ABV-S34 | | | |

### Example 8—Evaluation of Stability and Antibacterial Performance of Coating Compositions (Hereinafter Referred to as ABV Formulations) Using a 3-Month Accelerated Test

ABV-S29 and ABV-S34 were evaluated in terms of the electrical conductivity (EC), total dissolved solids (TDS), pH value, physical appearance, and antibacterial performance under accelerated storage condition (40±2° C., 75±5% RH) for three months.

Both formulations demonstrated stable EC with steady TDS values throughout the storage period. The pH value of ABV-S29 remained at 5.3-5.4, while ABV-S34 formulation stayed at pH 5.7-6.3 (Table 10 and Table 11). Both formulations appeared to be homogeneous and translucent, which there was no phase separation observed during the storage (FIG. 18).

TABLE 10
Stability study of formulation ABV-S29 after three-month storage at accelerated
condition (40 ± 2° C., 75 ± 5% RH)

| | | EC | TDS | | |
|---|---|---|---|---|---|
| Formulation | Storage time | (μS/cm) | (mg/L) | pH | Appearance |
| ABV-S29 | Day 0 | 2380 ± 10 | 1700 ± 10 | 5.30 ± 0.01 | Translucent |
| | | | | | solution, no phase |
| | | | | | separation |
| | Month 1 | 2370 ± 10 | 1680 ± 10 | 5.32 ± 0.01 | Translucent |
| | | | | | solution, no phase |
| | | | | | separation |
| | Month 2 | 2430 ± 10 | 1746 ± 10 | 5.44 ± 0.01 | Translucent |
| | | | | | solution, no phase |
| | | | | | separation |
| | Month 3 | 2517 ± 10 | 1787 ± 10 | 5.59 ± 0.01 | Translucent |
| | | | | | solution, no phase |
| | | | | | separation |

TABLE 11
Stability study of formulation ABV-S34 after three-month storage at accelerated
condition (40 ± 2° C., 75 ± 5% RH)

| | Storage | | TDS | | |
|---|---|---|---|---|---|
| Formulation | time | EC (mS/cm) | (g/L) | pH | Appearance |
| ABV-S34 | Day 0 | 13.050 ± 0.045 | 9.260 ± 0.032 | 5.76 ± 0.05 | Translucent |
| | | | | | solution, no phase |
| | | | | | separation |
| | Month 1 | 13.150 ± 0.046 | 9.350 ± 0.021 | 5.75 ± 0.02 | Translucent |
| | | | | | solution, no phase |
| | | | | | separation |
| | Month 2 | 13.190 ± 0.023 | 9.360 ± 0.015 | 6.00 ± 0.03 | Translucent |
| | | | | | solution, no phase |
| | | | | | separation |
| | Month 3 | 13.997 ± 0.068 | 9.900 ± 0.038 | 6.27 ± 0.01 | Translucent |
| | | | | | solution, no phase |
| | | | | | separation |

Antibacterial performance of formulation ABV-S29 and ABV-S34 were evaluated with reference to industrial standard BS EN 1276 (Please refer to methodology description in Example 6), using 10% softener JX-090 stored under accelerated condition for the same duration as the control. The formulation exhibited over 99.9999% antibacterial effect against S. aureus throughout the storage period (Table 12). Overall, the formulation was stable in the three-month accelerated storage, which was equivalent to two-year stable shelf-life storage under real time condition (25±2° C., 60±5% RH).

TABLE 12
Antibacterial performance of formulation ABV-S29 and
ABV-S34 against S. aureus after three-month storage
at accelerated condition (40 ± 2° C., 75 ± 5% RH)

| | | Bacteria | | |
|---|---|---|---|---|
| | | recovered | Bacteria | |
| | | from | recovered | |
| | | 10% softener | from formulation | Percent |
| | Storage | (control) | ABV-S29 | reduction |
| Formulation | time | (CFU) | (CFU) | (%) |
| ABV-S29 | Day 0 | 3.97E+08 | <100 | >99.9999 |
| | Month 1 | 1.12E+09 | <100 | >99.99999 |
| | Month 2 | 6.83E+08 | <100 | >99.9999 |
| | Month 3 | 1.02E+09 | <100 | >99.99999 |
| ABV-S34 | Day 0 | 7.63E+08 | <100 | >99.9999 |
| | Month 1 | 1.01E+09 | <100 | >99.99999 |
| | Month 2 | 6.27E+08 | <100 | >99.9999 |
| | Month 3 | 5.10E+08 | <100 | >99.9999 |

### Example 9—Fabric Coating by Pad-Dry-Cure Process with ABV-S29 and ABV-S34 Formulations

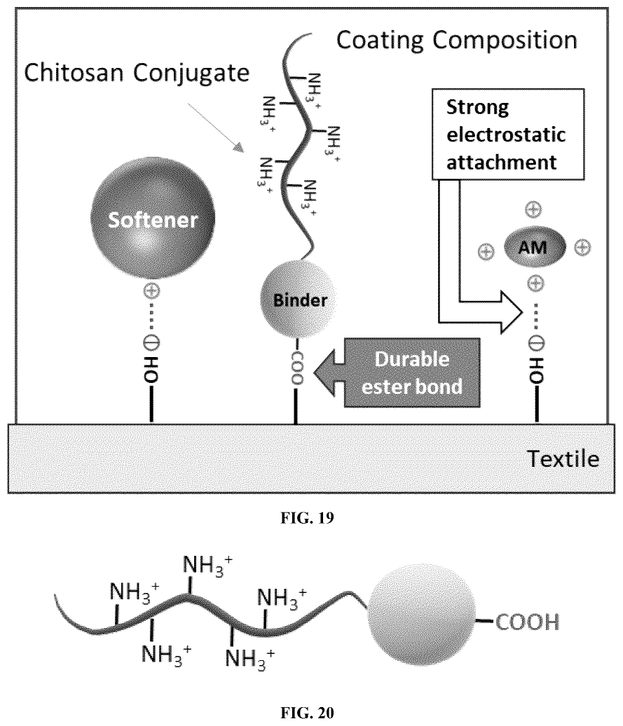

ABV-S29 formulation was applied on 100% cotton, polyester/cotton (20/80) and polyester/cotton (40/60) knit fabrics, while ABV-S34 was applied to polyester/cotton/spandex (62/33/5) by pad-dry-cure coating (Table 13). The pad-dry-cure coating process provides a durable coating of chitosan conjugate, antimicrobial agents, and softener to the surface of fabrics as shown in FIG. 19. Preferably, the chitosan conjugate (FIG. 20) has —COOH groups for forming ester bonds with —OH on the fabrics (cotton component). The cationic antimicrobial agents establish a strong electrostatic attachment to the —OH groups on the fabrics (cotton component). The softener is also cationic and can electrostatically attach to the fabrics (cotton component).

Coating on polyester/cotton/spandex (62/33/5) required a pre-treatment on textiles by gluconic acid (GA) (Table 13) because polyester/cotton/spandex (62/33/5) contained less cotton. Binding of the chitosan conjugate on fabrics relied on the formation of durable ester bonds between the carboxyl groups on the conjugate and hydroxyl groups on cotton-based fabrics in pad-dry-cure coating. When cotton content on fabric was less than 50%, the fabric was pre-coated with an aqueous sugar acid solution by pad-dry-cure coating to attain more hydroxyl groups for binding to the pH-responsive chitosan conjugate in ABV formulation (FIG. 21).

TABLE 13
Content, types, and weight of fabric substrates
for coating with ABV formulations by pad-dry-cure

| Fabric | Fabric | Weight | Coating |
|---|---|---|---|
| content | type | (gsm) | formulation |
| 100% Cotton | Jersey | 135 | ABV-S29 |
| Polyester/Cotton/Spandex | Jersey | 220 | GA + ABV-S34 |
| (62/33/5) | | | |
| Polyester/Cotton (40/60) | French Terry | 250 | ABV-S29 |
| Polyester/Cotton (20/80) | French Terry | 320 | ABV-S29 |

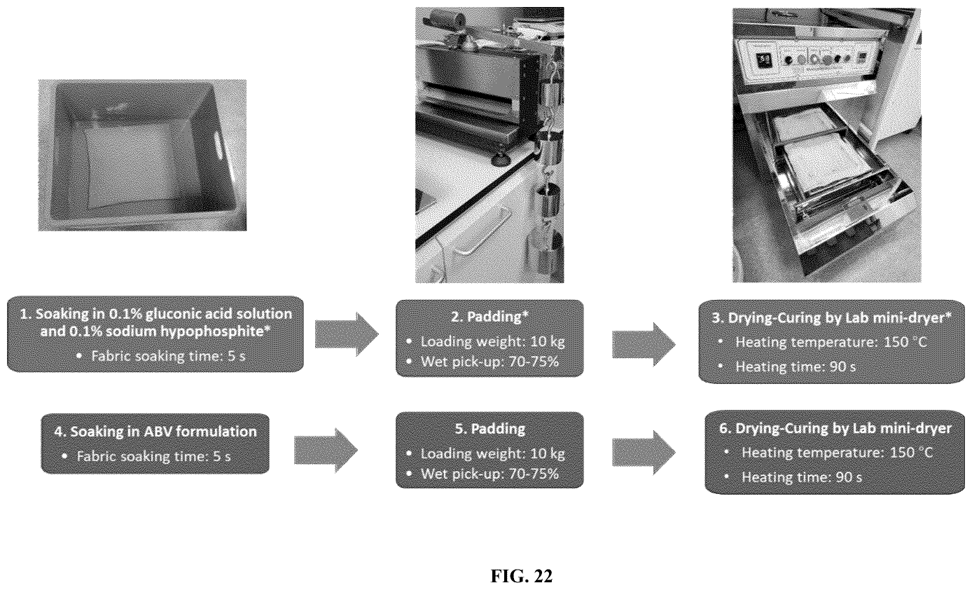

The coating process for ABV-29 formulation was shown as steps 4-6 in Figure. 22 (Steps 1-3 were not required). In optimizing the coating process for 100% cotton, polyester/cotton (20/80) and polyester/cotton (40/60) with ABV-S29 formulation, the fabrics were individually immersed in the formulation ABV-S29 for 5 seconds. The soaked fabric was passed through a lab wringer with applied 10 kg loading weights to remove unabsorbed formulation (padding). The weight of fabrics before and after soaking with formulation was monitored to achieve the target wet pick-up of 70-75%. Fabrics with the target wet pick-up were dried and cured by a lab mini dryer at 150° C. for 90 seconds.

The coating process for ABV-34 formulation was shown as steps 1-6 in FIG. 22. Prior to coating with ABV-S34 formulation, polyester/cotton/spandex (62/33/5) fabrics were pre-soaked in an aqueous solution of 0.1% gluconic acid (GA) with 0.1% sodium hypophosphite for 5 seconds, followed by padding to attain fabric wet pick-up of 70-75%. The fabrics were dried and cured by lab mini dryer at 150° C. for 90 seconds. The GA loaded fabrics were soaked again in ABV-S34 for 5 seconds, followed by padding, drying, and curing in the same conditions to produce polyester/cotton/spandex fabrics with GA+ABV-S34 coating.

### Example 10—Evaluation of Physical Dimensional Change of Fabric after Coated with Coating Compositions (Hereinafter Referred to as ABV Formulations)

Dimensions of fabrics were monitored before and after coating with pH-responsive ABV formulations with reference to industrial standard AATCC TM96. Before coating, the fabrics were conditioned at room temperature for at least 4 hours and marked with 25 cm² squares parallel to the fabric length (warp direction) and width (weft direction) with shrinkage template scale. The marked lengths (L) and widths (W) of the marked squares were then measured. After pad-dry-cure coating, the fabrics were pressed with iron gently to remove wrinkles and conditioned for at least 4 hours. The dimensions of the marked squares on the fabrics were measured again after the conditioning. The same procedures were performed on fabrics coated with 10% softener only, which served as the control for comparing the dimensional change for fabrics with ABV formulation.

Table 14 summarizes the dimensional changes of fabrics with ABV formulations from 10% softener coating. All fabric types exhibited less than 5% change in both lengths and widths, which was acceptable. Such changes were mostly caused by the padding process during coating when a weight of 10 kg was exerted onto the fabrics to remove excess formulation. 100% Cotton fabric with ABV-S29 and polyester/cotton/spandex (62/33/5) fabrics with GA+ABV-S34 were observed to have relatively high dimensional changes compared to other fabric types, probably due to relatively low fabric weights. The relatively high fabric weight of both French Terry types of polyester/cotton fabrics might have also contributed to minimal effect in the dimensional changes after coating.

TABLE 14
Dimensional change of textiles after coating
with coating compositions (ABV formulations)

| | 10% softener (Control) Vs coating | |
|---|---|---|
| | composition dimensional change | |
| Fabric type | ΔL* (%) | ΔW* (%) |
| 100% Cotton Jersey with ABV-S29, 135 gsm | +3.4 | −2.9 |
| Polyester/Cotton/Spandex (62/33/5) Jersey with | +3.1 | +3.8 |
| GA + ABV-S34, 135 gsm | | |
| Polyester/Cotton (40/60) French Terry with ABV-S29, | +0.6 | −0.4 |
| 250 gsm | | |
| Polyester/Cotton (20/80) French Terry with ABV-S29, | +0.3 | −0.4 |
| 320 gsm | | |

*Length was measured along the fabric warp direction and denoted as “L”. Width was measured along the fabric weft direction and denoted as “W”.

### Example 11—Evaluation of Color Change of Fabric Prototypes with Coating Compositions (Hereinafter Referred to as ABV Formulations)

Color of the fabrics were measured by spectrophotometer in terms of CIELAB color space, using 10° observer angle and Specular Component Included (SCI) mode with D65 light source. The color of the fabrics were represented by parameters L*, a* and b*. Color of fabrics with coating of pH-responsive ABV formulations was compared with fabrics coated with 10% softener as the control and the color difference was represented by delta E (ΔE). Delta E value less than or equal to 1 was considered as not perceptible by human eyes, while delta E values of 1-2 were perceptible through close observation.

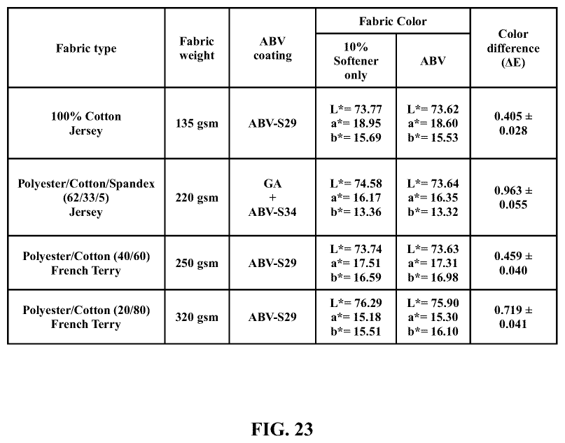

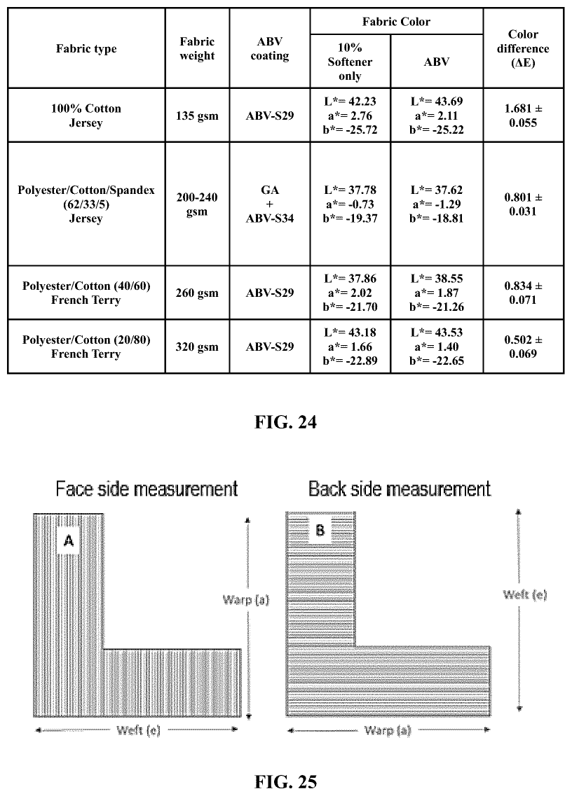

Fabrics dyed with coral and blue colors were evaluated after coating with ABV formulations and 10% softener. 100% Cotton, polyester/cotton/spandex (62/33/5), polyester/cotton (40/60) and polyester/cotton (20/80) fabrics in coral color showed ΔE less than 1 between 10% softener and ABV coating (FIG. 23). Polyester/cotton/spandex (62/33/5), polyester/cotton (40/60) and polyester/cotton (20/80) fabrics in blue color presented ΔE less than 1. However, 100% cotton in blue exhibited ΔE of 1.68 (FIG. 24). The color evaluation suggested formulation ABV-S29 was compatible with polyester/cotton (40/60) and polyester/cotton (20/80) in both coral and blue colors. Formulation ABV-S34 coating was compatible on both blue and coral colored polyester/cotton/spandex (62/33/5) fabrics and exhibited better color durability for blue color due to a lower ΔE value. The coral 100% cotton exhibited compatible property with ABV-S29, however, blue 100% cotton was not compatible with ABV-S29 due to a ΔE value at 1.681±0.055 (FIG. 24).

### Example 12—Texture Evaluation of Fabric Prototypes with Coating Compositions (Hereinafter Referred to as ABV Formulations)

Texture of fabrics with pH-responsive ABV formulations was accessed by Fabric Touch Tester (FTT). The evaluated fabrics were 100% cotton with ABV-S29, polyester/cotton/spandex (62/33/5) with ABV-S34, polyester/cotton (40/60) with ABV-S29 and polyester/cotton (20/80) with ABV-S29. L-Shaped specimens were cut from fabrics along the warp and weft directions and conditioned at room temperature for at least 24 hours before measurement by FTT (FIG. 25). Texture parameters including bending, compression, friction and roughness of both face and back sides of fabrics were evaluated and summarized in in Tables 15-22. Fabrics with 10% softener coating were also measured and served as a control group for texture comparison (Tables 15-22). All types of fabrics with the corresponding ABV formulation coating exhibited a change of less than 10% on the above texture parameters compared with the fabrics coated by 10% softener only.

TABLE 15
Texture evaluation on the face side of 100% cotton
fabrics with 10% softener and ABV-S29 formulation

| | | 100% Cotton Jersey, 135 gsm (Face) | | |
|---|---|---|---|---|
| | | 10% Softener | | Percentage |
| Texture parameter | | only (Control) | ABV-S29 | Change |
| Bending | Bending Average | 110.55 ± 7.57 | 111.83 ± 8.97 | +1.2% |
| | Rigidity | | | |
| | (gf*mm/rad) | | | |
| | Bending Work | 511.34 ± 31.07 | 510.26 ± 41.19 | −0.2% |
| | (gf*mm*rad) | | | |
| Compression | Thickness (mm) | 0.38 ± 0.01 | 0.39 ± 0.01 | +2.6% |
| | Compression | 0.49 ± 0.02 | 0.47 ± 0.03 | −4.1% |
| | Recovery Rate | | | |
| Friction | Surface Friction | 0.26 ± 0.01 | 0.26 ± 0.00 | 0.0% |
| | Coefficient | | | |
| Roughness | Surface Roughness | 33.65 ± 0.92 | 35.03 ± 3.10 | +4.1% |
| | Amplitude (μm) | | | |
| | Surface Roughness | 2.84 ± 0.17 | 2.62 ± 0.35 | −7.7% |
| | Wavelength (mm) | | | |

TABLE 16
Texture evaluation on the back side of 100% cotton
fabrics with 10% softener and ABV-S29 formulation

| | | 100% Cotton Jersey, 135 gsm (Back) | | |
|---|---|---|---|---|
| | | 10% Softener | | Percentage |
| Texture parameter | | only (Control) | ABV-S29 | Change |
| Bending | Bending Average | 105.48 ± 9.29 | 107.15 ± 2.61 | +1.6% |
| | Rigidity | | | |
| | (gf*mm/rad) | | | |
| | Bending Work | 369.54 ± 30.86 | 353.65 ± 51.99 | −4.3% |
| | (gf*mm*rad) | | | |
| Compression | Thickness (mm) | 0.40 ± 0.02 | 0.39 ± 0.03 | −0.6% |
| | Compression | 0.49 ± 0.01 | 0.47 ± 0.02 | −3.7% |
| | Recovery Rate | | | |
| Friction | Surface Friction | 0.23 ± 0.01 | 0.25 ± 0.01 | +5.0% |
| | Coefficient | | | |
| Roughness | Surface Roughness | 22.89 ± 1.00 | 24.57 ± 1.37 | +7.4% |
| | Amplitude (μm) | | | |
| | Surface Roughness | 1.55 ± 0.00 | 1.55 ± 0.00 | 0.0% |
| | Wavelength (mm) | | | |

TABLE 17
Texture evaluation on the face side of polyester/cotton/spandex
(62/33/5) fabrics with 10% softener and GA + ABV-S34 formulation

| | | Polyester/Cotton/Spandex (62/33/5) Jersey, 200-240 gsm (Face) | | |
|---|---|---|---|---|
| | | 10% Softener only | | |
| Texture parameter | | (Control) | GA + ABV-S34 | Percentage Change |
| Bending | Bending | 95.90 ± 6.01 | 103.41 ± 11.21 | +7.8% |
| | Average | | | |
| | Rigidity | | | |
| | (gf*mm/rad) | | | |
| | Bending | 272.23 ± 23.34 | 271.38 ± 31.51 | +0.4% |
| | Work | | | |
| | (gf*mm*rad) | | | |
| Compression | Thickness | 0.59 ± 0.03 | 0.55 ± 0.01 | −7.3% |
| | (mm) | | | |
| | Compression | 0.50 ± 0.02 | 0.46 ± 0.02 | −7.1% |
| | Recovery | | | |
| | Rate | | | |
| Friction | Surface | 0.45 ± 0.05 | 0.43 ± 0.04 | −4.8% |
| | Friction | | | |
| | Coefficient | | | |
| Roughness | Surface | 58.18 ± 3.38 | 53.34 ± 9.43 | −8.3% |
| | Roughness | | | |
| | Amplitude | | | |
| | (μm) | | | |
| | Surface | 1.99 ± 0.15 | 2.02 ±0.18 | +1.5% |
| | Roughness | | | |
| | Wavelength | | | |
| | (mm) | | | |

TABLE 18
Texture evaluation on the back side of polyester/cotton/spandex
(62/33/5) fabrics with 10% softener and GA + ABV-S34 formulation

| | | Polyester/Cotton/Spandex Jersey (62/33/5), 200-240 gsm | | |
|---|---|---|---|---|
| | | (Back) | | |
| | | 10% Softener only | | |
| Texture parameter | | (Control) | GA + ABV-S34 | Percentage Change |
| Bending | Bending | 76.85 ± 5.22 | 78.56 ± 15.57 | +2.2% |
| | Average | | | |
| | Rigidity | | | |
| | (gf*mm/rad) | | | |
| | Bending | 217.38 ± 25.09 | 213.94 ± 30.27 | −1.6% |
| | Work | | | |
| | (gf*mm*rad) | | | |
| Compression | Thickness | 0.58 ± 0.03 | 0.54 ± 0.01 | −7.0% |
| | (mm) | | | |
| | Compression | 0.50 ± 0.01 | 0.47 ± 0.02 | −6.1% |
| | Recovery | | | |
| | Rate | | | |
| Friction | Surface | 0.25 ± 0.01 | 0.24 ± 0.01 | −3.5% |
| | Friction | | | |
| | Coefficient | | | |
| Roughness | Surface | 35.90 ± 4.82 | 32.80 ± 1.43 | −8.6% |
| | Roughness | | | |
| | Amplitude | | | |
| | (μm) | | | |
| | Surface | 2.50 ± 0.69 | 2.66 ± 0.43 | +6.6% |
| | Roughness | | | |
| | Wavelength | | | |
| | (mm) | | | |

TABLE 19
Texture evaluation on the face side of polyester/cotton
(40/60) fabrics with 10% softener and ABV-S29 formulation

| | | Polyester/Cotton (40/60) French Terry, | | |
|---|---|---|---|---|
| | | 260 gsm (Face) | | |
| | | 10% Softener | | Percentage |
| Texture parameter | | only (Control) | ABV-S29 | Change |
| Bending | Bending Average | 144.16 ± 10.07 | 142.54 ± 10.86 | −1.1% |
| | Rigidity | | | |
| | (gf*mm/rad) | | | |
| | Bending Work | 604.18 ± 43.13 | 618.14 ± 43.13 | +2.3% |
| | (gf*mm*rad) | | | |
| Compression | Thickness (mm) | 1.14 ± 0.02 | 1.12 ± 0.02 | −1.4% |
| | Compression | 0.44 ± 0.02 | 0.44 ± 0.01 | +0.5% |
| | Recovery Rate | | | |
| Friction | Surface Friction | 0.39 ± 0.03 | 0.42 ± 0.04 | +8.0% |
| | Coefficient | | | |
| Roughness | Surface Roughness | 369.22 ± 29.15 | 387.77 ± 18.34 | +5.0% |
| | Amplitude (μm) | | | |
| | Surface Roughness | 1.89 ± 0.01 | 1.99 ± 0.07 | +5.8% |
| | Wavelength (mm) | | | |

TABLE 20
Texture evaluation on the back side of polyester/cotton
(40/60) fabrics with 10% softener and ABV-S29 formulation

| | | Polyester/Cotton (40/60) French Terry, | | |
|---|---|---|---|---|
| | | 260 gsm (Back) | | |
| | | 10% Softener | | Percentage |
| Texture parameter | | only (Control) | ABV-S29 | Change |
| Bending | Bending Average | 157.01 ± 6.15 | 163.33 ± 7.93 | +4.0% |
| | Rigidity | | | |
| | (gf*mm/rad) | | | |
| | Bending Work | 810.41 ± 49.63 | 860.62 ± 26.59 | +6.2% |
| | (gf*mm*rad) | | | |
| Compression | Thickness (mm) | 1.06 ± 0.03 | 1.08 ± 0.02 | +2.3% |
| | Compression | 0.48 ± 0.01 | 0.49 ± 0.01 | +0.7% |
| | Recovery Rate | | | |
| Friction | Surface Friction | 0.30 ± 0.00 | 0.30 ± 0.01 | +1.6% |
| | Coefficient | | | |
| Roughness | Surface Roughness | 122.21 ± 5.37 | 120.99 ± 6.64 | −1.0% |
| | Amplitude (μm) | | | |
| | Surface Roughness | 2.71 ± 0.22 | 2.57 ± 0.20 | −5.0% |
| | Wavelength (mm) | | | |

TABLE 21
Texture evaluation on the face side of polyester/cotton
(20/80) fabrics with 10% softener and ABV-S29 formulation

| | | Polyester/Cotton (20/80) French Terry, 320 gsm (Face) | | |
|---|---|---|---|---|
| | | 10% Softener | | Percentage |
| Texture parameter | | only (Control) | ABV-S29 | Change |
| Bending | Bending Average | 232.62 ± 17.30 | 232.33 ± 38.36 | −0.1% |
| | Rigidity | | | |
| | (gf*mm/rad) | | | |
| | Bending Work | 988.12 ± 68.68 | 1026.53 ± 10.05 | +3.9% |
| | (gf*mm*rad) | | | |
| Compression | Thickness (mm) | 1.27 ± 0.00 | 1.29 ± 0.03 | +1.7% |
| | Compression | 0.39 ± 0.03 | 0.38 ± 0.04 | −3.4% |
| | Recovery Rate | | | |
| Friction | Surface Friction | 0.36 ± 0.02 | 0.36 ± 0.02 | +1.3% |
| | Coefficient | | | |
| Roughness | Surface | 253.15 ± 36.95 | 240.28 ± 18.80 | −5.1% |
| | Roughness | | | |
| | Amplitude (μm) | | | |
| | Surface | 1.98 ± 0.18 | 1.87 ± 0.26 | −5.4% |
| | Roughness | | | |
| | Wavelength (mm) | | | |

TABLE 22
Texture evaluation on the back side of polyester/cotton
(20/80) fabrics with 10% softener and ABV-S29 formulation

| | | Polyester/Cotton (20/80) French Terry, 320 gsm (Back) | | |
|---|---|---|---|---|
| | | 10% Softener | | Percentage |
| Texture parameter | | only (Control) | ABV-S29 | Change |
| Bending | Bending Average | 229.47 ± 5.46 | 232.49 ± 12.47 | +1.3% |
| | Rigidity | | | |
| | (gf*mm/rad) | | | |
| | Bending Work | 1404.05 ± 39.69 | 1494.60 ± 50.81 | +6.4% |
| | (gf*mm*rad) | | | |
| Compression | Thickness (mm) | 1.21 ± 0.02 | 1.28 ± 0.02 | +5.6% |
| | Compression | 0.48 ± 0.02 | 0.45 ± 0.03 | −7.2% |
| | Recovery Rate | | | |
| Friction | Surface Friction | 0.24 ± 0.00 | 0.26 ± 0.00 | +6.8% |
| | Coefficient | | | |
| Roughness | Surface | 48.98 ± 2.65 | 50.04 ± 2.79 | +2.1% |
| | Roughness | | | |
| | Amplitude (μm) | | | |
| | Surface | 2.39 ± 0.18 | 2.19 ± 0.18 | −8.2% |
| | Roughness | | | |
| | Wavelength (mm) | | | |

### Example 13—Evaluation of Antibacterial Performance of Fabric Prototypes with Coating Compositions (Hereinafter Referred to as ABV Formulations) Against Staphylococcus aureus (S. aureus) after Laundry

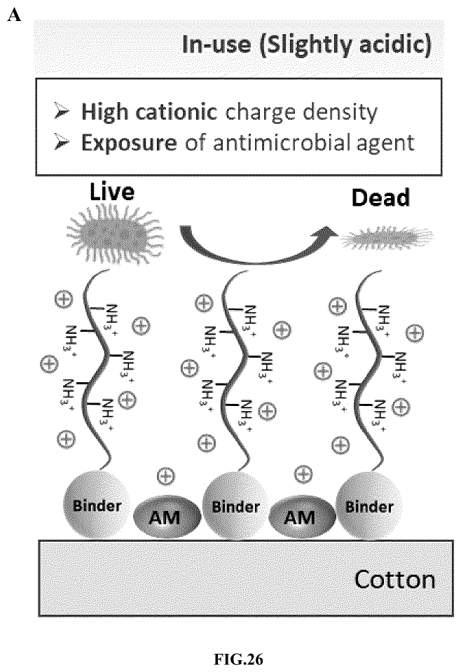

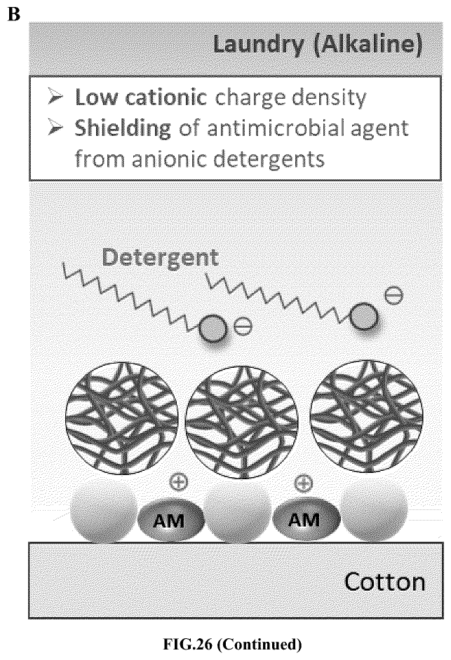

During laundry where the coated fabrics are in alkaline condition, the pH-responsive ABV formulation coating becomes hydrophobic and shields the antimicrobial agents from complexation with anionic surfactants, reducing the loss of the antimicrobial protection on the fabrics. A graphic illustration is shown in Figure. 26. The fabric in use are exposed to microorganisms and the antimicrobial agent linked to the fabrics can kill them. When the fabrics are washed with anionic alkaline detergent, the chitosan conjugate bound to the fabrics can advantageously form a protective shield to prevent the antimicrobial agents from contacting the detergents.

The antibacterial performance of fabrics coated by the ABV formulations was evaluated by accredited laboratory (Bureau Veritas Hong Kong Limited). Prior to the evaluation, the fabrics were laundered according to the industrial standard AATCC 61-2A (Accelerated washing cycles: 1 cycle was equivalent to 5 home laundry cycles) by accredited laboratory (Bureau Veritas Hong Kong Limited) to achieve 50 home laundry cycles, using 0.23% “Tide® Simply Free & Sensitive Unscented™” laundry detergent (Proctor & Gamble Company). The fabrics were washed for 45 min at 49° C., followed by rinsing with cold tap water for 30 seconds, and then hand wrung and dried in each cycle. The fabrics were evaluated for antibacterial reduction against S. aureus (ATCC strain no. 6538) after 24-hours incubation with the S. aureus according to the industrial standard AATCC 100. The 100% cotton with ABV-S29 coating exhibited over 99.9% antibacterial effect after 50 home laundry cycles. The polyester/cotton/spandex (62/33/5) with GA+ABV-S34 coating exhibited over 93.4% antibacterial effect after 50 home laundry cycles (Table 23).

TABLE 23
Antibacterial performance against S. aureus
of the fabrics with ABV coating after laundry

| | Percent reduction |
|---|---|
| | against S. aureus |
| Test Fabric | (ATCC strain no. 6538) |
| 100% Cotton | ≥99.9% |
| with ABV-S29 | (after 50 home laundry cycles) |
| Polyester/Cotton/Spandex (62/33/5) | ≥93.4% |
| with GA + ABV-S34 | (after 50 home laundry cycles) |

### Example 14—Evaluation of Antibacterial Performance of Fabric Prototypes with Coating Compositions (Hereinafter Referred to as ABV Formulations) Against Escherichia coli (E. coli) after Laundry

The antibacterial performance of fabrics coated by pH-responsive ABV formulations was evaluated by accredited laboratory (Bureau Veritas Hong Kong Limited and Hong Kong Certification Centre). Prior to the evaluation, the fabrics were laundered according to the industrial standard AATCC 61-2A (Accelerated washing cycles: 1 cycle was equivalent to 5 home laundry cycles) by accredited laboratory (Bureau Veritas Hong Kong Limited and Hong Kong Certification Centre) to achieve 50 home laundry cycles, using 0.23% “Tide® Simply Free & Sensitive Unscented™” laundry detergent (Proctor & Gamble Company). The fabrics were washed for 45 min at 49° C., followed by rinsing with cold tap water for 30 seconds, and then hand wrung and dried in each cycle. The fabrics were evaluated for antibacterial reduction against E. coli (ATCC strain no. 25922 and 8739) after 24-hours incubation with the E. coli according to industrial standard AATCC 100. The 100% Cotton with ABV-S29 coating exhibited over 99.9% antibacterial effect after 50 home laundry cycles. The polyester/cotton/spandex (62/33/5) with GA+ABV-S34 coating exhibited over 99% antibacterial effect after 50 home laundry cycles (Table 24).

TABLE 24
Antibacterial performance against E. coli
of the fabrics with ABV coating after laundry

| | Percent reduction against E. coli |
|---|---|
| Test fabric | (ATCC strain no. 25922 and 8739) |
| 100% Cotton | ≥99.9% |
| with ABV-S29 | (after 50 home laundry cycles) |
| Polyester/Cotton/Spandex (62/33/5) | ≥99% |
| with GA + ABV-S34 | (after 50 home laundry cycles) |

### Example 15—In-House Antibacterial Test of 100% Cotton, Polyester/Cotton (40/60) and Polyester/Cotton (20/80) Fabrics with ABV-S29 Coating after Different Laundry Cycles

Antibacterial performance of the 100% cotton, polyester/cotton (40/60) and polyester/cotton (20/80) fabrics with ABV-S29 coating were evaluated in-house after washing. The fabrics were laundered by washing machine at 40° C. for 60 minutes, using standard reference detergent AATCC 1993 WOB (without optical brightener), followed by tumble drying at 60° C. for at least 60 minutes. Fabric samples after 20, 30, 40, 45 and 50 home laundry cycles were collected for in-house antibacterial test with reference to dilution-neutralization method of industrial standard AATCC 100. Briefly, the fabrics were inoculated with tryptic soy broth (TSB) suspension of S. aureus at concentration of 10⁶⁻⁸ cfu/mL for 24 hours. At the end of the incubation, bacteria on the inoculated fabrics were extracted with Dey/Engley (D/E) neutralizing broth for 1 minute to neutralize the antibacterial action from the ABV softener formulation. The D/E neutralized incubation solution was then serial-diluted by phosphate-buffered saline (PBS) and cultured on tryptic soy agar (TSA) plates, which were incubated at 37° C. for 18-24 hours. The bacterial colonies formed on the agar plates were quantified and compared with bacterial colonies obtained at 0 hour of the incubation, which served as the control. The antibacterial performance of the fabrics was expressed in terms of percent reduction according to Equation 2. Table 25-27 summarize the average number of bacterial colonies recovered from ABV coated fabrics at 0 hour and 24 hours after different laundry cycles. All fabrics demonstrated over 90% antibacterial effect against S. aureus after 20, 30, 40, 45 and 50 home laundry cycles.

$$Percent reduction ( \% ) = \frac{( A - B )}{A} \times 100$$

A=Bacteria recovered from fabric at 0 h contact with bacteria (cfu)
B=Bacteria recovered from fabric at 24 h contact with bacteria (cfu)
   Equation 2

TABLE 25
Antibacterial performance against S. aureus of 100% fabric
with ABV coating after 20-50 laundry cycles at t = 0 h and 24 h

| | | S. aureus bacterial | S. aureus bacterial | |
|---|---|---|---|---|
| | # | count on fabric | count on fabric | |
| | Laundry | sample at T = 0 h | sample at T = 24 h | Percent |
| Sample | cycle | (CFU) | (CFU) | reduction (%) |
| 100% Cotton with | 20 | 1.70E+06 | <100 | >99.99 |
| ABV-S29 | 30 | 1.02E+07 | 1.00E+03 | >99.99 |
| | 40 | 1.36E+06 | <100 | >99.99 |
| | 45 | 1.19E+06 | <100 | >99.99 |
| | 50 | 8.20E+05 | <100 | >99.9 |

TABLE 26
Antibacterial performance against S. aureus of the polyester/cotton (40/60)
fabric with ABV coating after 50 laundry cycles at t = 0 h and 24 h

| | | S. aureus bacterial | S. aureus bacterial | |
|---|---|---|---|---|
| | | count on fabric | count on fabric | |
| | # Laundry | sample at T = 0 h | sample at T = 24 h | Percent reduction |
| Sample | cycle | (CFU) | (CFU) | (%) |
| Polyester/Cotton | 50 | 1.08E+08 | 5.15E+06 | >95.21 |
| (40/60) with | | | | |
| ABV-S29 | | | | |

TABLE 27
Antibacterial performance against S. aureus of the polyester/cotton (20/80)
fabric with ABV coating after 50 laundry cycles at t = 0 h and 24 h

| | | S. aureus bacterial | S. aureus bacterial | |
|---|---|---|---|---|
| | | count on fabric | count on fabric | |
| | # Laundry | sample at T = 0 h | sample at T = 24 h | Percent reduction |
| Sample | cycle | (CFU) | (CFU) | (%) |
| Polyester/Cotton | 50 | 3.52E+07 | 1.55E+06 | >95.59 |
| (20/80) with | | | | |
| ABV-S29 | | | | |

### Example 16—Evaluation of the Stability of ABV Softener Coated Fabrics within 3-Month Accelerated Test

Antibacterial performance of the 100% cotton, polyester/cotton (40/60) and polyester/cotton (20/80) with ABV-S29 coating; and polyester/cotton/spandex (62/33/5) with GA+ABV-S34 coating were evaluated in-house after storage in accelerated condition (40±2° C., 75±5% RH) with reference to dilution-neutralization method of industrial standard AATCC 100. Briefly, the fabrics were inoculated with tryptic soy broth (TSB) suspension of S. aureus at concentration of 107 cfu/mL for 24 hours. At the end of the incubation, bacteria on the inoculated fabrics were extracted with Dey/Engley (D/E) neutralizing broth for 1 minute to neutralize the antibacterial action from the ABV softener formulation. The D/E neutralized incubation solution was then serial-diluted by phosphate-buffered saline (PBS) and cultured on tryptic soy agar (TSA) plates, which were incubated at 37° C. for 18-24 hours. The bacterial colonies formed on the agar plates were quantified and compared with bacterial colonies obtained at 0 hour of the incubation, which served as the control. The antibacterial performance of the fabrics was expressed in terms of percent reduction according to Equation 3. Table 28 summarizes the average number of bacterial colonies recovered from ABV coated fabric at 0 hour and 24 hours. All fabrics demonstrated over 99% antibacterial effect against S. aureus after the 3-month storage, which was equivalent to 2-year shelf-life in real time.

$$Percent reduction ( \% ) = \frac{( A - B )}{A} \times 100$$

A=Bacteria recovered from fabric at 0 h contact with bacteria (cfu)
B=Bacteria recovered from fabric at 24 h contact with bacteria (cfu)
   Equation 3

TABLE 28
Antibacterial performance against S. aureus of fabrics with
ABV coating after 3-month storage under accelerated condition

| | | | |
|---|---|---|---|
| Accelerated | | S. aureus | |
| condition | S. aureus bacterial count | bacterial count on | Percent |
| (40 ± 2° C., 75 ± 5% | on fabric sample | fabric sample | reduction |
| RH) storage time | at T = 0 h (CFU) | at T = 24 h (CFU) | (%) |

100% Cotton with ABV-S29

| | | | |
|---|---|---|---|
| Day 0 | 2.80E+06 | <100 | >99.996 |
| Month 1 | 1.90E+06 | <100 | >99.995 |
| Month 2 | 1.17E+06 | <100 | >99.991 |
| Month 3 | 1.50E+06 | <100 | >99.991 |

Polyester/Cotton/Spandex (62/33/5) with GA + ABV-S34

| | | | |
|---|---|---|---|
| Day 0 | 3.20E+07 | <100 | >99.9997 |
| Month 1 | 1.90E+06 | <100 | >99.9947 |
| Month 2 | 4.70E+06 | <100 | >99.996 |
| Month 3 | 1.40E+06 | <100 | >99.993 |

Polyester/Cotton (40/60) with ABV-S29

| | | | |
|---|---|---|---|
| Day 0 | 3.30E+05 | <100 | >99.97 |
| Month 1 | 2.31E+05 | <100 | >99.96 |
| Month 2 | 2.50E+04 | <100 | >99.60 |
| Month 3 | 9.00E+04 | <100 | >99.89 |

Polyester/Cotton (20/80) with ABV-S29

| | | | |
|---|---|---|---|
| Day 0 | 6.00E+04 | <100 | >99.83 |
| Month 1 | 1.87E+05 | <100 | >99.95 |
| Month 2 | 8.20E+04 | <100 | >99.88 |
| Month 3 | 3.50E+04 | <100 | >99.71 |

### Example 17—Comparison of Antibacterial Performance of Polyester/Cotton/Spandex (62/33/5) Fabric with and without Pre-Treatment Prior to Coating with ABV Formulation

Prior to coating with ABV-S32 formulation, polyester/cotton/spandex (62/33/5) fabrics were pre-soaked in an aqueous solution of 0.1% gluconic acid (GA) with 0.1% sodium hypophosphite for 5 seconds, followed by padding to attain fabric wet pick-up of 70-75%. The fabrics were dried and cured by lab mini dryer at 150° C. for 90 seconds. The GA loaded fabrics were soaked again in ABV-S32 for 5 seconds, followed by padding, drying, and curing in the same conditions to produce polyester/cotton/spandex fabrics with GA+ABV-S32 coating. Antibacterial performance of the fabric was evaluated in-house after washing, while fabric without pre-treatment with gluconic solution was served as control. The fabrics were laundered by washing machine at 40° C. for 60 minutes, using standard reference detergent AATCC 1993 WOB (Without optical brightener), followed by tumble drying at 60° C. for at least 60 minutes. Antibacterial activity of the fabric after 5 home laundry cycles was evaluated by in-house zone of inhibition tests, with particular focus on the antibacterial effect against E. coli. The fabric samples were incubated overnight on tryptic soy agar spread with S. aureus and E. coli at concentration of 10⁸ cfu.

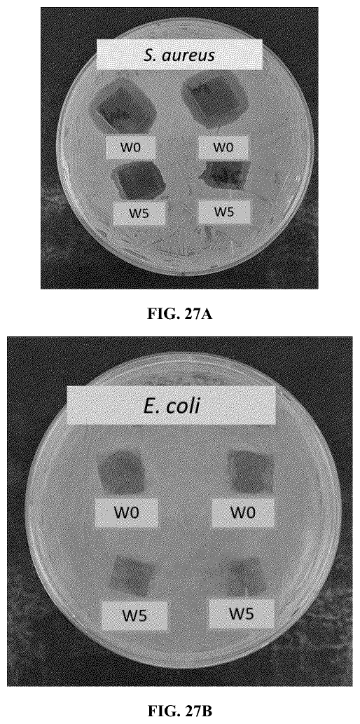

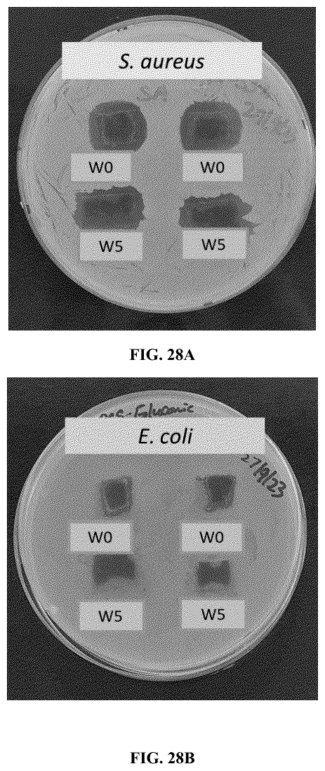

Fabric coated with formulation ABV-S32 without gluconic acid pre-treatment exhibited antibacterial effect against S. aureus only (FIG. 27A), but not E. coli after 5 laundry cycles (W5) (FIG. 27B). When pre-treated with gluconic acid, ABV-S32 coating was effective against S. aureus (FIG. 28A) and exhibited inhibitory effect against E. coli after 5 laundry cycles (W5), as the laundered fabrics showed less coverage by E. coli on the zone of inhibition test (FIG. 28B).

### Example 18—Scanning Electron Microscopy (SEM) Images of Fabrics with ABV Coating after Laundry

Morphology of 100% cotton fabric with ABV-S29 coating and polyester/cotton/spandex (62/33/5) fabric with GA+SBV-S34 coating after laundry was observed under scanning electron microscope (SEM). The fabrics were laundered by washing machine at 40° C. for 60 minutes, using standard reference detergent AATCC 1993 WOB (without optical brightener), followed by tumble drying at 60° C. for at least 60 minutes. Fabric samples after 10, 30, and 50 home laundry cycles were collected for imaging. The fabrics were sputter coated with gold prior to imaging by SEM (JEOL JSM-IT200).

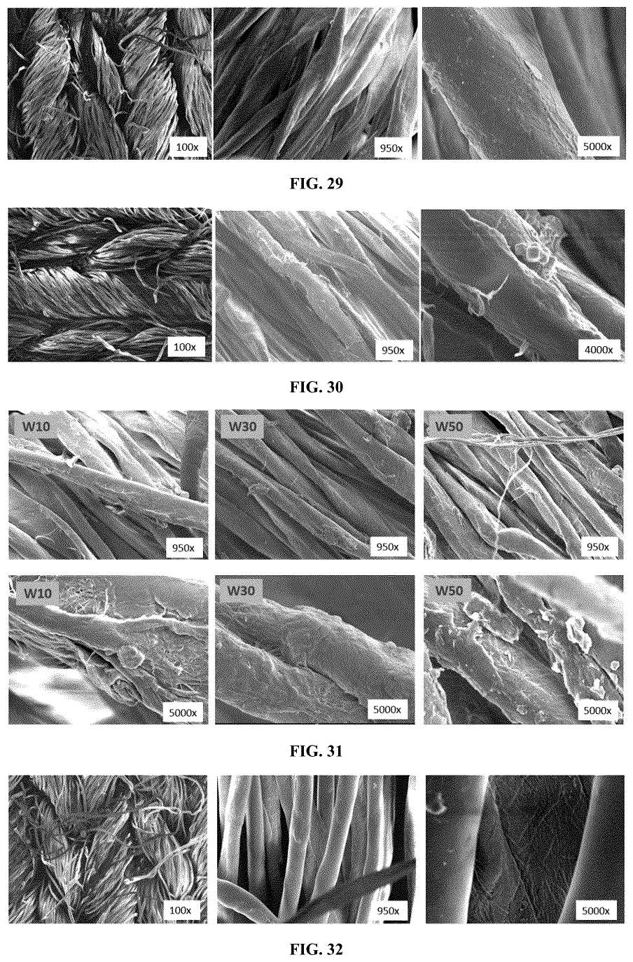

Morphology of 100% cotton fabric with ABV-S29 coating was observed to be different from fabric without coating. The coating appeared as layers covering the fibers, while fibers without coating appeared to be uniform on the surface. (FIG. 29-30). The coating could still be observed on the fibers after laundering of the fabric (FIG. 31).

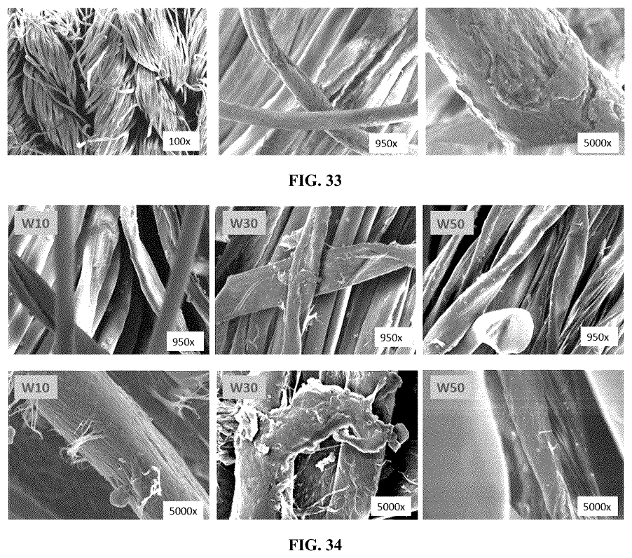

Three different fibers were observed on polyester/cotton/spandex (62/33/5) fabric. Cotton fibers could be distinguished by their uniform rough surface, while the surface of polyester and spandex fibers appeared to be smooth. GA+ABV-S34 Coating appeared as an extra layer, primarily covering the cotton fibers (FIG. 32-33). The coating could still be observed remaining on cotton fibers after laundering of the fabric (FIG. 34).

### Example 19—Evaluation of Antibacterial Performance of Fabric Prototypes with Coating Compositions (Hereinafter Referred to as ABV Formulations) Against Klebsiella pneumoniae (K. pneumoniae) after Laundry

The antibacterial performance of fabrics coated by pH-responsive ABV formulations was evaluated by accredited laboratory (Bureau Veritas Hong Kong Limited). Prior to evaluation, the fabrics were laundered according to the industrial standard AATCC 61-2A (accelerated washing cycles: 1 cycle was equivalent to 5 home laundry cycles) by accredited laboratory (Bureau Veritas Hong Kong Limited) to achieve 50 home laundry cycles, using 0.23% “Tide® Simply Free & Sensitive Unscented™” laundry detergent (Proctor & Gamble Company). The fabrics were washed for 45 min at 49° C.; followed by rinsing with cold tap water for 30 seconds, and then hand wrung and dried in each cycle. The fabrics were tested for antibacterial reduction against K. pneumoniae (ATCC strain no. 4352) after 24-hours incubation with K. pneumoniae according to the industrial standard AATCC 100. The 100% Cotton with ABV-S29 coating exhibited over 99.9% antibacterial effect after 50 home laundry cycles (Table 26).

TABLE 26
Antibacterial performance against K. pneumoniae
of 100% cotton with ABV coating after laundry

| | Percent reduction against K. pneumoniae |
|---|---|
| Test fabric | (ATCC strain no. 4352) |
| 100% Cotton | ≥90% |
| with ABV-S29 | (after 50 home laundry cycles) |

### Example 20—Evaluation of Antiviral Performance of Fabric Prototypes with Coating Compositions (Hereinafter Referred to as ABV Formulations) Against Human Coronavirus SARS-CoV-2 after Laundry

The antiviral performance of fabrics with coating of pH-responsive ABV formulation was evaluated by accredited laboratory (Virology Research Services). Prior to the evaluation, the fabrics were laundered according to the industrial standard AATCC 61-2A (Accelerated washing cycles: 1 cycle was equivalent to 5 home laundry cycles) by accredited laboratory (Bureau Veritas Hong Kong Limited) to achieve 50 home laundry cycles, using 0.23% “Tide® Simply Free & Sensitive Unscented™” laundry detergent (Proctor & Gamble Company). The fabrics were washed for 45 min at 49° C., followed by rinsing with cold tap water for 30 seconds, and then hand wrung and dried in each cycle. The fabrics were evaluated for antiviral reduction against human corona virus SARS-COV-2, strain Omicron BA.2 after 24-hour incubation with SARS-COV-2 virus following industrial standard ISO18184. The African Green Monkey Kidney (Vero) cells were used as the host cells for viral infection in the test. Both 100% Cotton fabric with ABV-S29 coating and polyester/cotton/spandex (62/33/5) fabric with GA+ABV-S34 coating exhibited over 99.99% antiviral performance against human coronavirus SARS-COV-2 after 50 home laundry cycles (Table 27).

TABLE 27
Antiviral performance against human coronavirus SARS-
CoV-2 of the fabrics with ABV coating after laundry

| | TCID Value of ABV | TCID value of control | Percent |
|---|---|---|---|
| Fabric Content | coated fabric (Log 10) | fabric (Log 10) | reduction |
| 100% Cotton | 1.90 | 6.07 | 99.99% |
| with ABV-S29 | | | (After 50 |
| | | | home |
| | | | laundry |
| | | | cycles) |
| | | | 99.99% |
| Polyester/Cotton/Spandex | 1.90 | 5.91 | (After 50 |
| (62/33/5) | | | home |
| with GA + ABV-S34 | | | laundry |
| | | | cycles) |

### Example 21—Safety Assessment of Fabric Prototypes with Coating Compositions (Hereinafter Referred to as ABV Formulations)

The safety of fabrics with coating of pH-responsive ABV formulations were assessed in terms of skin irritation, skin sensitization and acute dermal toxicity by accredited laboratories (Hangzhou C&K Testing Technic Co., Ltd.). All the fabrics, 100% Cotton, polyester/cotton/spandex (62/33/5), polyester/cotton (40/60) and polyester/cotton (20/80) with corresponding ABV formulation coating showed no observable irritation, sensitization, and acute toxicity to skin (Table 28).

TABLE 28
Safety assessment of fabric prototypes with ABV formulations

| | Skin irritation | Skin sensitization | Acute dermal toxicity |
|---|---|---|---|
| | (GB 15979- | (GB 15979- | (GB/T 16886.11 and |
| Fabric content | 2002) | 2002) | OECD 402) |
| 100% Cotton with ABV-S29 | Passed | Passed | Passed |
| Polyester/Cotton/Spandex | Passed | Passed | Passed |
| (62/33/5) with GA + ABV-S34 | | | |
| Polyester/Cotton | Passed | Passed | Passed |
| (40/60) with ABV-S29 | | | |
| Polyester/Cotton | Passed | Passed | Passed |
| (20/80) with ABV-S29 | | | |

What is claimed is:

1. A coating composition precursor comprising:
an antimicrobial agent;
an esterification catalyst; and
a chitosan conjugate, wherein the chitosan conjugate comprises a repeating unit of Formula I, 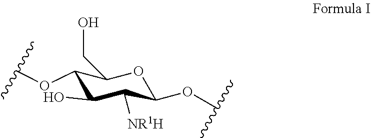
or a conjugate salt thereof, wherein
R¹ is —(C═O)(CH₂)ₘCO₂H; and
m is a whole number selected from 1-12.

2. The coating composition precursor of claim 1, wherein the antimicrobial agent is selected from the group consisting of biguanides comprising chlorhexidine salts, polyhexamethylene biguanide (PHMB), polyaminopropyl biguanide (PAPB), and a combination thereof.

3. The coating composition precursor of claim 1, wherein the esterification catalyst is selected from the group consisting of sodium bisulfate, potassium bisulfate, sodium hypophosphite, potassium hypophosphite, and a combination thereof.

4. The coating composition precursor of claim 1, wherein m is a whole number selected from 2-12.

5. The coating composition precursor of claim 1, wherein the antimicrobial agent is selected from the group consisting of biguanides comprising chlorhexidine salts, polyhexamethylene biguanide (PHMB), polyaminopropyl biguanide (PAPB), and a combination thereof; the esterification catalyst is selected from the group consisting of sodium bisulfate, potassium bisulfate, sodium hypophosphite, potassium hypophosphite, and a combination thereof; and m is a whole number selected from 2-12.

6. The coating composition precursor of claim 1, wherein the antimicrobial agent comprises chlorhexidine acetate or polyhexamethylene biguanide (PHMB); the esterification catalyst comprises sodium hypophosphite; and m is 4.

7. The coating composition precursor of claim 1, wherein the chitosan conjugate further comprises a repeating unit of Formula II and optionally a repeating unit of Formula III, 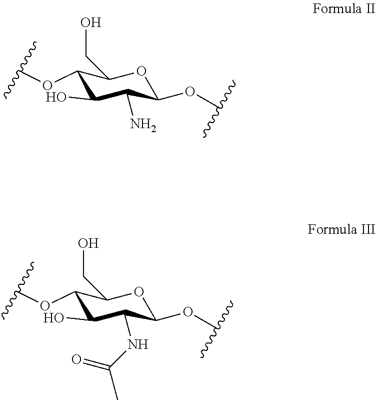
wherein the repeating unit of Formula I accounts for 6.67%-31.25% based on a total number of the repeating units of Formula I, repeating units of Formula II, and optionally the repeating units of Formula III in the chitosan conjugate.

8. A coating composition comprising the coating composition precursor of claim 1 and at least one solvent.

9. The coating composition of claim 8, wherein the at least one solvent comprises water.

10. The coating composition of claim 8 further comprising an additive, wherein the additive comprises a softener or cetyltrimethylammonium bromide.

11. The coating composition of claim 10, wherein the softener comprises a hydrophilic silicone softener.

12. The coating composition of claim 10 comprising: about 0.01-0.2% by weight of the chitosan conjugate, about 0.1-5% of the antimicrobial agent by weight, about 1-10% of the softener by weight, about 0.01-0.1% of the cetyltrimethylammonium bromide by weight, about 0.01-0.1% of the esterification catalyst by weight, and about 84.6-98.7% of the at least one solvent by weight.

13. The coating composition of claim 10 comprising: about 0.1% of the chitosan conjugate by weight, about 1% of the antimicrobial agent, by weight about 10% of the softener by weight, about 0.1% of the cetyltrimethylammonium bromide, and about 0.1% of the esterification catalyst by weight. and about 88.7% of the at least one solvent by weight, wherein the antimicrobial agent comprises a chlorhexidine acetate.

14. The coating composition of claim 10 comprising: about 0.1% of the chitosan conjugate by weight, about 5% of the antimicrobial agent by weight, about 10% of the softener by weight, 0.1% of the cetyltrimethylammonium bromide by weight, and about 0.1% of the esterification catalyst by weight and about 84.7% of the at least one solvent by weight, wherein the antimicrobial agent comprises a polyhexamethylene biguanide.

15. A coated textile comprising a textile and the coating composition precursor of claim 1 disposed on a surface of the textile.

16. The coated textile of claim 15, wherein at least a portion of the chitosan conjugate forms a covalent bond with the surface of the textile.

17. The coated textile of claim 15, wherein the coated textile exhibits at least 90% antimicrobial effect against one or more microbes selected from the group consisting of a bacteria, a virus, a combination thereof after 10 laundry cycles conducted in accordance with AATCC 61-2A or 50 home laundry cycles.

18. A method of preparing a coated textile, the method comprising: contacting a textile with the coating composition of claim 8 thereby forming an uncured coated textile and curing the uncured coated textile thereby forming the coated textile.

19. The method of claim 18, wherein the curing step is conducted under conditions in which at least a portion of the chitosan conjugate forms a covalent bond with a surface of the textile.

20. The method of claim 18, wherein the textile comprises a cellulosic fiber.

21. The method of claim 18, wherein the curing comprises heating the uncured coated textile at 120° C. to 160° C.

22. The method of claim 18 further comprising a pre-treatment step prior to the step of contacting the textile with the coating composition, wherein the pre-treatment step comprises: contacting the textile with sugar acid and sodium hypophosphite thereby forming an uncured pretreated textile, and curing the uncured pretreated textile under conditions in which at least a portion of the sugar acid forms a covalent bond with a surface of the textile.

23. The method of claim 22, wherein the textile comprises cotton and one or more of polyethylene terephthalate and spandex.
